(19) United States
(12) Patent Application Publication
(10) Pub. No.: US 2015/0188193 A1
(43) Pub. Date: Jul. 2, 2015

(54) NON-AQUEOUS LIQUID ELECTROLYTE FOR SECONDARY BATTERY AND SECONDARY BATTERY

(71) Applicant: FUJIFILM Corporation, Tokyo (JP)

(72) Inventors: Kunihiko KODAMA, Ashigarakami-gun (JP); Yoshinori KANAZAWA, Ashigarakami-gun (JP)

(73) Assignee: FUJIFILM CORPORATION, Tokyo (JP)

(21) Appl. No.: 14/659,697

(22) Filed: Mar. 17, 2015

Related U.S. Application Data
(63) Continuation of application No. PCT/JP2013/074705, filed on Sep. 12, 2013.

(30) Foreign Application Priority Data
Sep. 20, 2012 (JP) 2012-207166

(51) Int. Cl. H01M 10/0567; H01M 10/0525

(52) U.S. Cl. CPC H01M 10/0567; H01M 10/0525; H01M 2300/0025

(57) ABSTRACT

A non-aqueous liquid electrolyte for a secondary battery, containing: a compound (A) having a cyclopropane structure; an electrolyte; and an organic solvent, in which the compound (A) satisfies at least one selected from (Aa) to (Ac):
(Aa) a compound having two or more cyclopropane structures in the molecule thereof
(Ab) a compound having a cyclopropane structure and a group selected from an acryloyl group and a vinylphenyl group
(Ac) a compound having a cyclopropane structure and a particular group

### CROSS-REFERENCE TO RELATED APPLICATIONS

This application is a Continuation of PCT International Application No. PCT/JP2013/074705 filed on Sep. 12, 2013, which claims priority under 35 U.S.C. §119 (a) to Japanese Patent Application No. 2012-207166 filed on Sep. 20, 2012. Each of the above applications is hereby expressly incorporated by reference, in its entirety, into the present application.

### FIELD OF THE INVENTION

The present invention relates to a non-aqueous liquid electrolyte for a secondary battery containing an organic solvent, and a secondary battery using the same.

### FIELD OF THE INVENTION

Secondary batteries are called lithium ion batteries, currently attracting attention. They can broadly be classified into two categories of so called lithium ion secondary batteries and lithium metal secondary batteries. The lithium metal secondary batteries utilize precipitation and dissolution of lithium for the operation. Besides, the lithium ion secondary batteries utilize storage and release of lithium in the charge/discharge reaction. These batteries both can provide large energy densities as compared with lead batteries or nickel-cadmium batteries. By making use of this characteristic, in recent years, these batteries have been widely prevalent as a power supply for portable electronic equipment, such as camera-integrated VTR's (video tape recorders), mobile telephones, and notebook computers. In accordance with a further expansion of applications, the development of lightweight lithium ion secondary batteries such as to allow high energy densities has been advanced, as a power source of the portable electronic equipment.

The consideration on improvement in performance of the lithium ion secondary batteries has been advanced in various aspects of a liquid electrolyte, an electrode active material, a separator material, and the like. Looking at the liquid electrolyte in particular, various materials have been considered as candidate for a functional additive, and research and analysis have been carried out in an energetic way. The kind of such materials is too numerous to comprehensively list herein. However, it is possible to exemplify, for example, Patent Literatures 1 to 6 as cases in which an attempt to improve capacity retention characteristics was made.

### CITATION LIST

### Patent Literatures

Patent Literature 1: JP-A-5-74486 (“JP-A” means unexamined published Japanese patent application)
Patent Literature 2: JP-A-2007-265858
Patent Literature 3: JP-A-2001-6729
Patent Literature 4: JP-A-63-102173
Patent Literature 5: JP-A-2000-309583
Patent Literature 6: JP-A-6-302336

### SUMMARY OF THE INVENTION

### Problems that the Invention is to Solve

In the meantime, requirement for the lithium secondary battery is heading to higher level of performance and multi-functionalization, including enlargement of the lithium secondary battery to automotive application. In particular, there is a tendency for the charge/discharge and storage of the secondary battery to be carried out in a variety of temperature range, and as a result realization of high performance even under such environment has been desired. Thus, the inventors of the present invention focused attention on a retention property of the battery capacity at the time when a large-current discharge (high-rate discharge) is carried out under the various conditions, and large-current discharge characteristics after repetition of charge and discharge, in particular, a large-current discharge characteristics at the time of more severe low-temperature discharge. In general, an effort for improvement to those problems is not yet sufficient.

The present invention has been made in view of the foregoing points and, thus, the present invention is contemplated for providing: a secondary battery, which is excellent in large-current discharge characteristics (high-rate discharge characteristics), and moreover excellent in large-current discharge characteristics even after a charge/discharge has been carried out at a low-temperature or repeatedly; and a non-aqueous liquid electrolyte for a secondary battery, which is used in the foregoing secondary battery.

### Means to Solve the Problem

The present invention provides the following means.

[1] A non-aqueous liquid electrolyte for a secondary battery, containing: a compound (A) having a cyclopropane structure; an electrolyte; and an organic solvent,

wherein the compound (A) satisfies at least one selected from (Aa) to (Ac):

(Aa) a compound having two or more cyclopropane structures in the molecule thereof
(Ab) a compound having a cyclopropane structure and a group selected from an acryloyl group and a vinylphenyl group
(Ac) a compound having a cyclopropane structure and a group selected from among formulas (Ac-a) to (Ac-c)

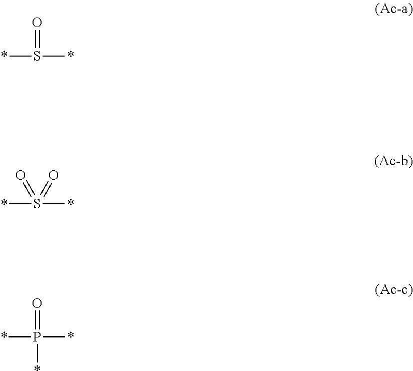

wherein “*” represents a binding site.

[2] The non-aqueous liquid electrolyte for a secondary battery as described in the item [1], wherein the compound (A) further contains at least one selected from the group consisting of a cyano group and an ester group.
[3] The non-aqueous liquid electrolyte for a secondary battery as described in the item [1] or [2], wherein the cyclopropane structure contained in the compound (A) has a partial structure represented by formula (Aa1):

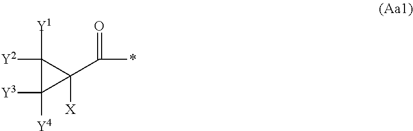

wherein X represents a hydrogen atom or a substituent; and Y¹ to Y⁴ each represent a hydrogen atom or a substituent.

[4] The non-aqueous liquid electrolyte for a secondary battery described in any one of the items [1] to [3], wherein the compound of (Aa) is a compound represented by formula (Aa3):

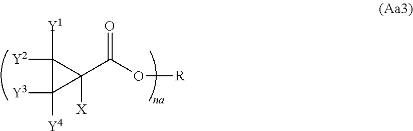

wherein X represents a hydrogen atom or a substituent; Y¹ to Y⁴ each represent a hydrogen atom or a substituent; na represents an integer of from 2 to 6; and R represents a linking group.

[5] The non-aqueous liquid electrolyte for a secondary battery described in any one of the items [1] to [3], wherein the compound of (Ab) is a compound represented by formula (Ab2):

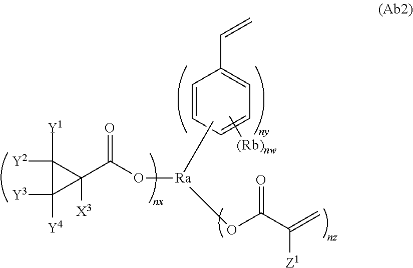

wherein Y¹ to Y⁴ each represent a hydrogen atom or a substituent; Z¹ represents a hydrogen atom, an alkyl group, a fluorine-substituted alkyl group, or a cyano group; X³ represents a hydrogen atom or a substituent; Ra represents a linking group; nx represents an integer of from 1 to 3; ny represents an integer of from 0 to 3; nz represents an integer of from 0 to 3; the sum of ny and nz is an integer of from 1 to 3; Rb represents a substituent; and nw is an integer of from 0 to 4.

[6] The non-aqueous liquid electrolyte for a secondary battery described in any one of the items [1] to [3], wherein the compound of (Ac) is a compound having a partial structure represented by formula (Ac1):

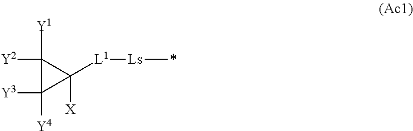

wherein L¹ represents a single bond or a linking group; Ls represents a linking group represented by any one of formulas (Ac-a) to (Ac-c); X represents a hydrogen atom or a substituent; Y¹ to Y⁴ each represent a hydrogen atom or a substituent; “*” represents a binding site; and the “*” site may bind to any one of Y¹ to Y⁴ and X, or may bind to a cyclopropane ring by eliminating any of the Y¹ to Y⁴ and X, to form a ring structure containing Ls.

[7] The non-aqueous liquid electrolyte for a secondary battery as described in any one of the items [1] to [6], further containing a compound releasing, upon oxidation or reduction, an active species that reacts with the compound (A).
[8] A non-aqueous liquid electrolyte secondary battery, containing:

a positive electrode;

a negative electrode; and

the non-aqueous liquid electrolyte described in any one of the items [1] to [7].

[9] The non-aqueous liquid electrolyte secondary battery described in the item [8], wherein a compound having at least one of nickel, cobalt, or manganese is contained as an active material of the positive electrode.
[10] The non-aqueous liquid electrolyte secondary battery described in the item [8] or [9], wherein lithium titanium oxide (LTO) or a (composite) carbon material is contained as an active substance of the negative electrode.
[11] An additive for a non-aqueous secondary battery liquid electrolyte, comprising a compound satisfying any one selected from (Aa) to (Ac):
(Aa) a compound having two or more cyclopropane structures in the molecule thereof
(Ab) a compound having a cyclopropane structure and a group selected from an acryloyl group and a vinylphenyl group
(Ac) a compound having a cyclopropane structure and a group selected from among formulas (Ac-a) to (Ac-c)

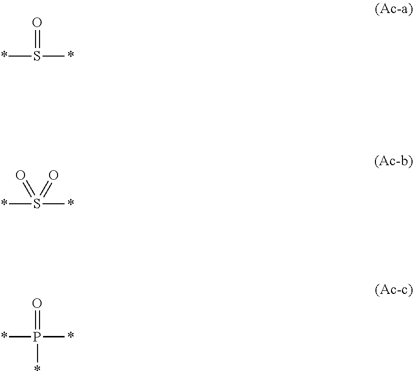

wherein “*” represents a binding site.

In this specification, when there are a plurality of substituents or linking groups marked with specific signs, or when a plurality of substituents and the like are defined at the same time or individually, each of the substituents and the like may be the same as or different from each other. This is applicable to definition of the number of the substituent or the like as well. Moreover, unless otherwise specified, when a plurality of substituents and the like come close to each other, they may be linked or condensed, to form a ring.

### Effects of the Invention

The non-aqueous liquid electrolyte and the non-aqueous liquid electrolyte secondary battery of the present invention, are excellent in large-current discharge characteristics (high-rate discharge characteristics), and moreover excellent in large-current discharge characteristics even after a charge/discharge has been carried out at a low-temperature or repeatedly.

Other and further features and advantages of the invention will appear more fully from the following description, appropriately referring to the accompanying drawings.

### BRIEF DESCRIPTION OF THE DRAWINGS

FIG. 1 is a cross-sectional diagram schematically illustrating a mechanism of a lithium secondary battery according to a preferable embodiment of the present invention.

FIG. 2 is a cross-sectional diagram schematically illustrating a specific configuration of a lithium secondary battery according to a preferable embodiment of the present invention.

### MODE FOR CARRYING OUT THE INVENTION

Hereinafter, an embodiment of the present invention is described in detail. However, the present invention is not construed by being limited thereto.

### [Non-Aqueous Liquid Electrolyte for a Secondary Battery]

### (Compound (A))

The non-aqueous liquid electrolyte of the present invention, contains: the compound (A) having a cyclopropane structure, wherein the compound (A) satisfies at least one selected from (Aa) to (Ac):

(Aa) a compound having two or more cyclopropane structures in the molecule thereof
(Ab) a compound having a cyclopropane structure and a group selected from an acryloyl group and a vinylphenyl group
(Ac) a compound having a cyclopropane structure and a group selected from among formulas (Ac-a) to (Ac-c)

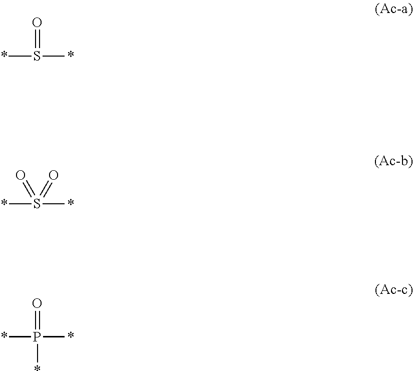

wherein “*” represents a binding site.

The compound (A) may be a compound which satisfies a plurality of the requirements among the foregoing (Aa) to (Ac). For example, the compound (A) may be a compound, which contains two or more cyclopropane structures in the molecule thereof and contains a group selected from among formulas (Ac-a) to (Ac-c).

The compound (A) further preferably contains an ester group and/or a cyano group, and more preferably it is a compound having a cyclopropane structure to which the ester group and/or the cyano group binds. The ester group means a group containing an ester-linking group (—C(═O)O—). In an embodiment in which an alkyl group is located at the O-side, a structure is formed in such a way that the cyclopropane structure has an alkoxycarbonyl group.

Compound of (Aa)

In the case where the compound (A) having a cyclopropane structure is a compound of (Aa) having two or more cyclopropane structures in the molecule thereof, the number of cyclopropane structures is preferably from 2 to 6, more preferably from 2 to 4, and still more preferably 2 or 3.

The cyclopropane structure contained in the compound of (Aa) is preferably a partial structure represented by formula (Aa1), and more preferably a partial structure represented by formula (Aa2).

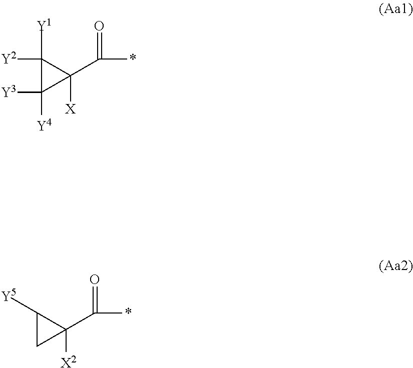

X

In formula (Aa1), X represents a hydrogen atom or a substituent; preferably a hydrogen atom, an alkyl group (preferably those having 1 to 8 carbon atoms, more preferably those having 1 to 4 carbon atoms), a cyano group, a group containing a phosphonic acid group (preferably those having 1 to 8 carbon atoms, more preferably those having 1 to 4 carbon atoms, and most preferably dialkylphosphonic acid groups), a group containing a sulfonyl group (preferably those having 1 to 8 carbon atoms, more preferably those having 1 to 4 carbon atoms, and most preferably alkylsulfonyl or arylsulfonyl groups having the foregoing number of carbon atoms), an alkoxycarbonyl group (preferably those having 2 to 10 carbon atoms, and more preferably those having 2 to 4 carbon atoms), an acyl group (preferably those having 2 to 10 carbon atoms, and more preferably those having 2 to 4 carbon atoms), an aryl group (preferably those having 6 to 12 carbon atoms), or an alkenyl group (preferably those having 2 to 8 carbon atoms, and more preferably those having 2 to 4 carbon atoms). The substituent, such as an alkyl group, may be further substituted by the substituent T described below, and may be substituted with, for example, a fluorine atom.

Y¹ to Y⁴

Y¹ to Y⁴ each represent a hydrogen atom or a substituent; preferably a hydrogen, an alkyl group (preferably having 1 to 8 carbon atoms, more preferably having 1 to 4 carbon atoms), an alkenyl group (preferably having 2 to 8 carbon atoms, more preferably having 2 to 4 carbon atoms), an aryl group (preferably having 6 to 12 carbon atoms), or an alkoxycarbonyl group (preferably having 2 to 10 carbon atoms, more preferably having 2 to 4 carbon atoms). From the viewpoint of improvement in reactivity at the negative electrode, in the case where all of Y¹ to Y⁴ each are a hydrogen atom, X is preferably an electron-withdrawing group (positive in terms of up), and more preferably a cyano group, an alkoxycarbonyl group (preferably those having 2 to 10 carbon atoms), a phosphonic acid group-containing group, a sulfonyl group-containing group, or a trifluoromethyl group.

Y⁵

In formula (Aa2), Y⁵ preferably has the same meanings as Y¹ to Y⁴, more preferably a hydrogen atom or a vinyl group.

X²

X² represents a group having the same meaning as X.

Specific examples of the cyclopropane structure contained in the compound of (Aa) include the following partial structures.

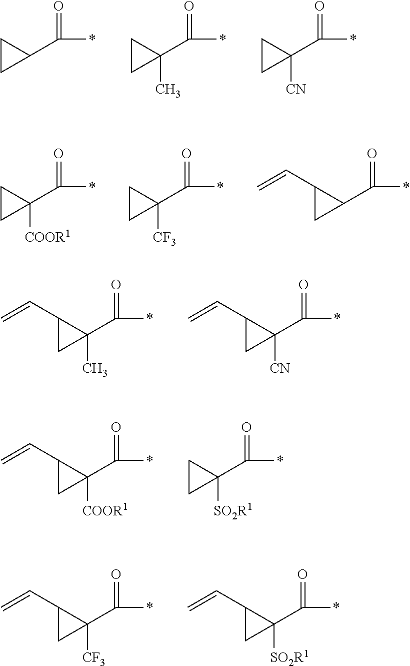

R¹ represents an organic group. Preferred examples thereof include an alkyl group having 1 to 20 carbon atoms, an alkenyl group having 2 to 10 carbon atoms, an aryl group having 6 to 20 carbon atoms, and an aralkyl group having 7 to 20 carbon atoms.

The compound of (Aa) is preferably a compound in which a partial structure represented by formula (Aa1) or (Aa2) is esterified to a polyvalent alcohol in place of a part or all of hydrogen atoms of the hydroxy groups thereof, or a compound in which a partial structure represented by formula (Aa1) or (Aa2) is attached to a nitrogen atom of a multi-valent nitrogen-containing compound in amide linkage, and more preferably a compound represented by formula (Aa3), and still more preferably a compound represented by formula (Aa4).

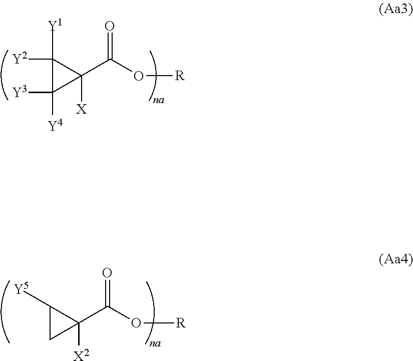

In formulas (Aa3) and (Aa4), X, Y¹ to Y⁴, Y⁵, and X² have the same meanings as those in formula (Aa1) or (Aa2).

R represents a na-valent linking group, preferably an alkane linking group [an alkylene group as long as it is divalent] (preferably those having 1 to 12 carbon atoms, and more preferably those having 1 to 4 carbon atoms), an aryl linking group [an arylene group as long as it is divalent] (preferably those having 6 to 24 carbon atoms, and more preferably those having 6 to 10 carbon atoms), an aralkyl linking group [an aralkylene group as long as it is divalent] (preferably those having 7 to 30 carbon atoms, and more preferably those having 7 to 11 carbon atoms), a heterocyclic linking group (preferably those having 2 to 12 carbon atoms, and more preferably those having 2 to 6 carbon atoms), or a linking group in which a plurality of these groups are combined directly or via a linking group having a hetero atom (preferably —O—, —(C═O)O—, —S—, —SO₂—, —SO₃—). In particular, R is preferably an alkane linking group [e.g. an alkylene group] which may have an ether group in a chain of 2 to 12 carbon atoms (more preferably 2 to 6 carbon atoms), or a linking group in which a plurality of these groups are combined. The linking group mentioned in the above-described [ ] represents a divalent linking group which is included in the group defined there.

na represents an integer of from 2 to 6, preferably an integer of from 2 to 4, further preferably 2 or 3, and particularly preferably 2. When na is 2 or more, a plurality of the structures defined there may be different from one another.

The compound of (Aa) is further preferably a compound represented by any of the following formulas.

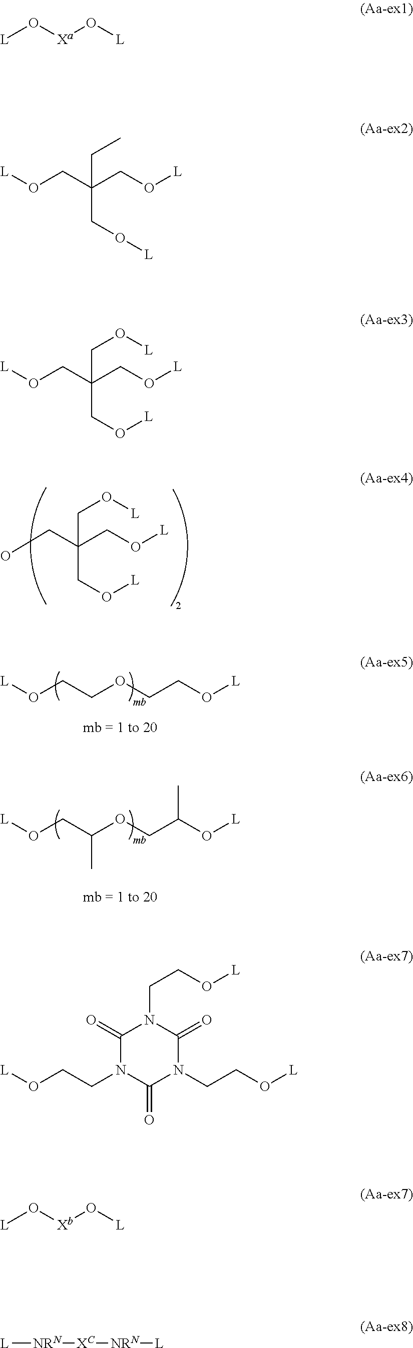

In formulas, L represents a hydrogen atom or a structure represented by formula (Aa1) (preferably a structure represented by formula (Aa2)). However, two or more structures represented by formula (Aa1) are present in one molecule.

R^{N} represents a hydrogen atom or a substituent (preferably an alkyl group having 1 to 6 carbon atoms). R^{N} may be linked with L, to form a ring.

X^{a} represents a linear, branched or cyclic alkylene group having 2 to 20 carbon atoms, or a combination of these.

X^{b} is a linking group containing an arylene group having 6 to 30 carbon atoms, preferably a phenylene group, a xylylene group, -Ph-Ph-, —CH₂-Ph-CH₂—, -Ph-C(CH₃)₂-Ph-, -Ph-C(CF₃)₂-Ph-, -Ph-O-Ph-, -Ph-S-Ph-, -Ph-S(═O)-Ph-, -Ph-S(═O)₂-Ph-, or a biphenylene group. Herein, Ph represents a phenylene group.

X^{c} represents an alkylene group having 1 to 24 carbon atoms, an alkenylene group having 1 to 24 carbon atoms, a heterocyclic group having 1 to 24 carbon atoms, or an arylene group having 6 to 24 carbon atoms. In particular, X^{c} preferably forms a hetero ring together with NR^{N}, and more preferably forms a piperazine ring with NR^{N}—X^{C}—NR^{N}.

Specific examples of the compound of (Aa) are shown below. Herein, Y⁶ is a hydrogen atom or a vinyl group. Me is a methyl group, and Et is an ethyl group. These abbreviations are common in the present specification. Further, Ph represents a phenyl group.

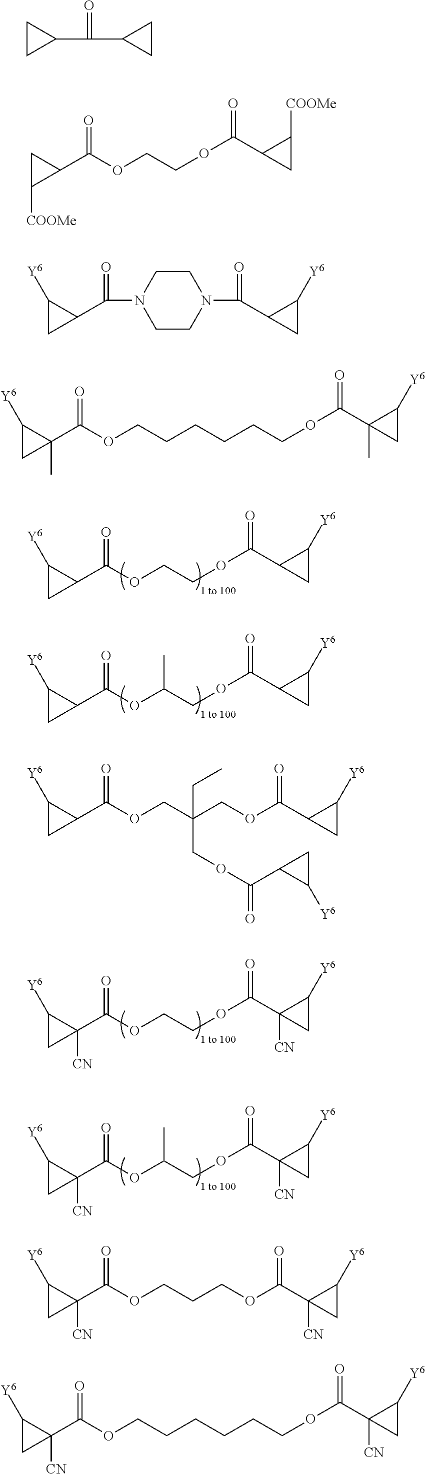

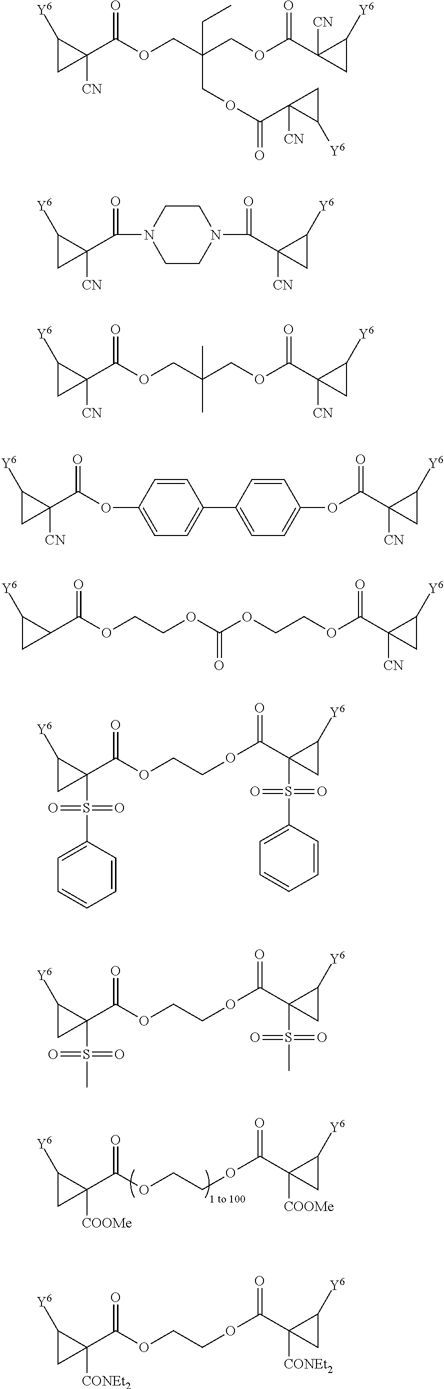

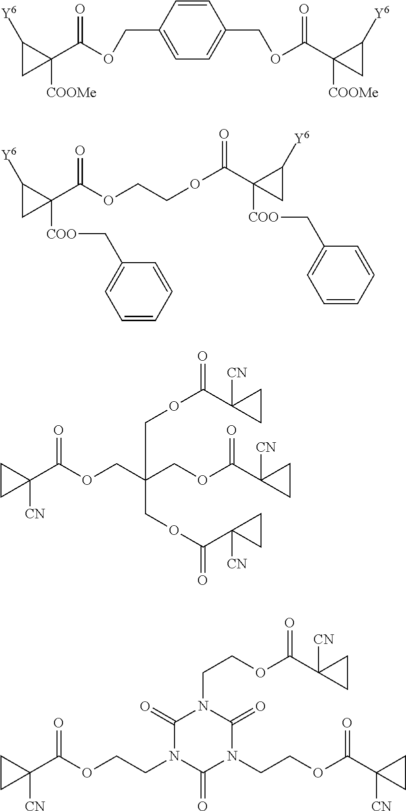

Compound of (Ab)

The compound of (Ab) having a cyclopropane structure and a group selected from an optionally substituted acryloyl group or vinylphenyl group is preferably a compound having from 1 to 3 cyclopropane structures and from 1 to 3 groups selected from such an acryloyl group or vinylphenyl group. The cyclopropane structure, which the compound of (Ab) has, is preferably the above-described structure represented by formula (Aa1), and more preferably a structure represented by formula (Aa2). The acryloyl group, which the compound of (Ab) has, is preferably a partial structure represented by formula (Ab1). In the present specification, the term acryloyl group is used in the sense that this includes not only an acryloyl group in which the group at the α-position (Z¹ in formula (Ab1) described below) is a hydrogen atom, but also an acryloyl group in which the group at the α-position is a methyl group (i.e. a methacryloyl group) or other acryloyl groups in which the group at the α-position is an arbitrary other substituent, such as a fluorinated alkyl group, a cyano group, or the like.

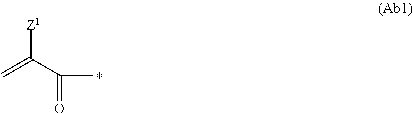

In formula (Ab1), Z¹ represents a hydrogen atom, an alkyl group (preferably a methyl group), a fluorine-substituted alkyl group (preferably a trifluoromethyl group), or a cyano group. “*” represents a binding site.

The compound of (Ab) is preferably a compound represented by formula (Ab2).

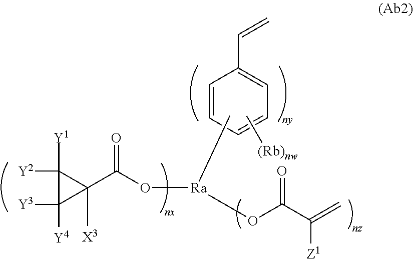

Y¹ to Y⁴ and Z¹ have the same meanings as those described below.

X³ is a hydrogen atom, or a substituent, and preferable examples thereof are the same as those of the above-described X.

Ra is a linking group. Preferable examples of Ra include the above-described examples of R, more preferably a linking group having from 1 to 20 carbon atoms, still more preferably a linking group having from 1 to 10 carbon atoms, and particularly preferably a linking group having from 1 to 4 carbon atoms. The linking group is preferably an alkane linking group [an alkylene group as long as it is divalent] or an alkaneoxy linking group [an alkyleneoxy group as long as it is divalent]. The valence of the linking group comes to a total of nx, ny and nz.

nx represents an integer of from 1 to 3, preferably 1.

ny represents an integer of from 0 to 3.

nz represents an integer of from 0 to 3.

The sum of ny and nz is an integer of from 1 to 3.

Rb represents a substituent, and nw represents an integer of from 0 to 4.

When nx, ny, or nz is 2 or more, a plurality of the structures defined respectively there may be different from one another.

Specific examples of the compound of (Ab) are shown below. Herein, Y⁶ is a hydrogen atom or a vinyl group. Z¹ has the same meaning as that in formula (Ab1).

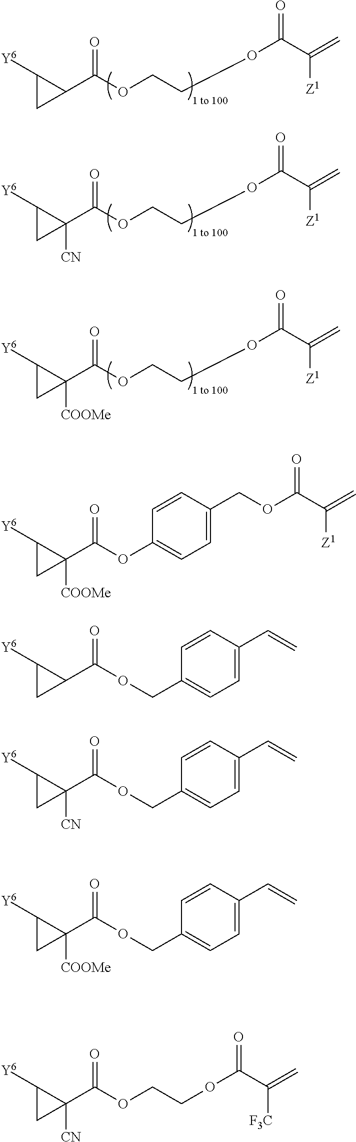

Compound of (Ac)

The compound of (Ac) has a cyclopropane structure (preferably a structure represented by formula (Aa1) or (Aa2)) and a linking group represented by any one of formulas (Ac-a), (Ac-b) and (Ac-c). As the group selected from any one of formulas (Ac-a) to (Ac-c), a group represented by any one of formulas (Ac-a1), (Ac-a2), (Ac-a3), (Ac-b1), (Ac-b2), (Ac-b3), (Ac-b4) and (Ac-c1) is more preferable.

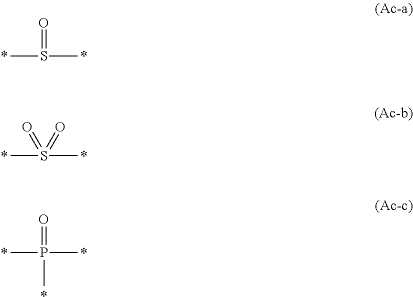

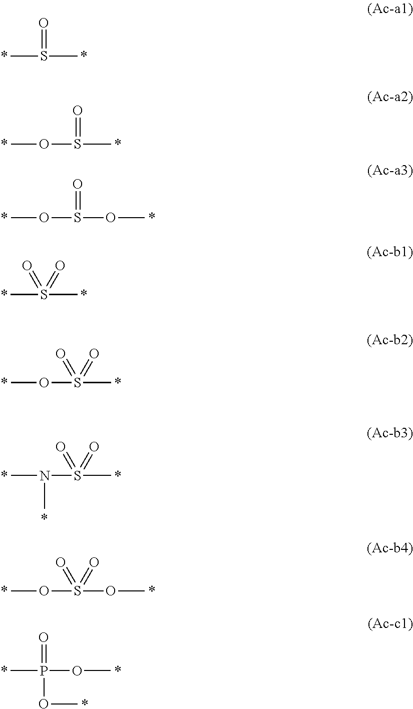

The compound having the group represented by any one of formulas (Ac-a) to (Ac-c) is preferably a compound having a partial structure represented by formula (Ac1), and more preferably a compound having a partial structure represented by formula (Ac2).

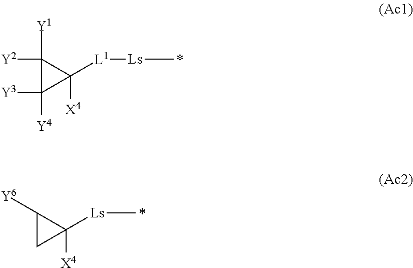

L¹ represents a single bond or a linking group. Examples of the linking group include those exemplified as the above-described R (formula (Aa3)).

Ls represents a group having a group selected from any one of formulas (Ac-a) to (Ac-c), and Ls is preferably a group selected from any one of formulas (Ac-a1), (Ac-a2), (Ac-a3), (Ac-b1), (Ac-b2), (Ac-b3), (Ac-b4) and (Ac-c1).

The site may bind to any of Y¹ to Y⁴ and X⁴, or may bind to a cyclopropane ring by eliminating any of Y¹ to Y⁴ and X⁴, to form a cyclic compound containing Ls.

Y¹ to Y⁴ have the same meanings as those described above.

A plurality of the (Ac1) structures may be contained in the molecule, in such a way that the (Ac1) structures are combined together via a linking group from any site of Y¹ to Y⁴, X⁴ and *.

Y⁶ is a group having the same meaning as Y¹ to Y⁴, and preferably a hydrogen atom or a vinyl group.

X⁴ is a group having the same meaning as X.

The compound of (Ac) is particularly preferably a compound represented by any one of formulas (Ac3) to (Ac7).

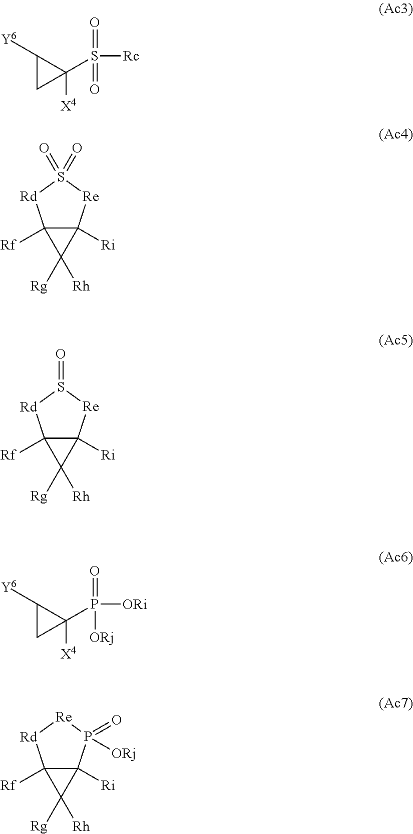

Y⁶ and X⁴ have the same meanings as those described above.

Rc is an alkyl group (preferably having 1 to 20 carbon atoms, more preferably having 1 to 4 carbon atoms), an aryl group (preferably having 6 to 12 carbon atoms, more preferably a phenyl group), an aralkyl group (preferably having 7 to 12 carbon atoms), or an amino group (preferably having 0 to 20 carbon atoms, more preferably having 0 to 4 carbon atoms). At that time, Rc or X⁴ may be a group having the structure of formula (Ac3) via a linking group or a single bond. That is to say, a structure having a plurality of structures (except for a group which will become a linking group or a single bond) defined by formula (Ac3) may be formed by Rc or X⁴.

Rd and Re each represent a single bond, an alkylene group (preferably those having 1 to 8 carbon atoms, and more preferably those having 1 to 4 carbon atoms), —O—, or a linking group in which a plurality of these groups are combined together. At that time, it is preferable that a 5- to 7-membered ring containing Rd and Re is formed.

Rf to Rj each are an alkyl group (preferably having 1 to 8 carbon atoms, more preferably having 1 to 4 carbon atoms), an aryl group (preferably having 6 to 12 carbon atoms), an alkenyl group (preferably having 7 to 13 carbon atoms), or a hydrogen atom.

Of these, the compound represented by formula (Ac3) is preferable, and a compound represented by any one of formulas (Ac3-1) to (Ac3-7) is particularly preferable.

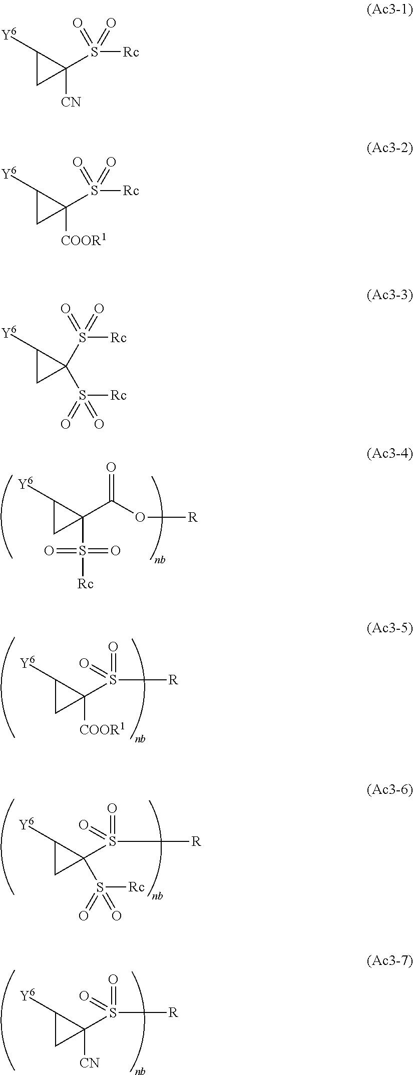

R, Rc and R¹ each represent the group having the same meanings as those described above. Herein, Y⁶ is a hydrogen atom or a vinyl group.

nb represents an integer of from 2 to 6, preferably an integer of from 2 to 4, and particularly preferably 2. When nb is 2 or more, a plurality of the structures defined there may be different from one another.

Specific examples of the compound of (Ac) are shown below. Herein, Y⁶ is a hydrogen atom or a vinyl group.

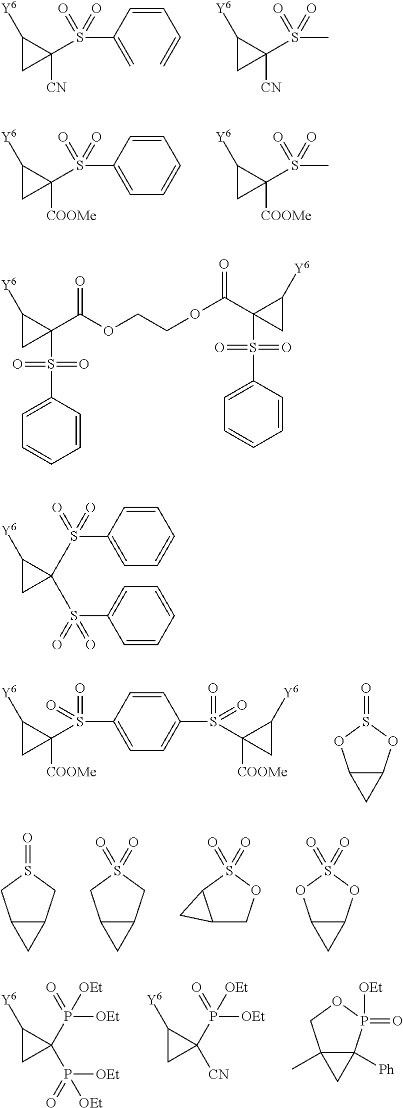

The addition amount of the compound (A) is preferably 0.001 mass % or greater, more preferably 0.005 mass % or greater, and still more preferably 0.01 mass % or greater, with respect to the entire liquid electrolyte. The upper limit thereof is preferably 10 mass % or less, more preferably 5 mass % or less, further preferably 1 mass % or less, and particularly preferably 0.5 mass % or less. By controlling the addition amount to the above-described range, a desired high-temperature capacity retention property and high-rate characteristics can be achieved each at a high level, while maintaining a favorable discharge performance, which is preferable.

### (Compound (B))

The non-aqueous liquid electrolyte of the present invention for a secondary battery preferably contains a compound (B) which releases, upon oxidation or reduction, an active species that reacts with the compound (A). The compound (A) works more efficiently due to this material, so that occurrence of irreversible capacity is suppressed by a small amount thereof and the battery performance is improved. As for the active species that the compound (B) releases upon oxidation or reduction, a radical, an anion or a cation is preferable, and a radical and/or an anion are/is more preferable. In particular, preferred is a compound which produces an anion radical when the compound is reduced at the anode, or a compound which produces an anion radical when the compound is reduced at the anode, and further produces an anion and/or radical upon decomposition thereof.

Examples of the compound are preferably a ketone compound, an oxime ester compound, an oxime ether compound, a sulfonium salt, and an iodinium salt. An aromatic ketone compound is more preferable. Further more preferred are an acetophenone compound, a benzophenone compound, a 9-fluorenone compound, an anthrone compound, a xanthone compound, a dibenzosuberone compound, a dibenzosuberenone compound, an anthraquinone compound, a bianthronyl compound, a bianthrone compound, and a dibenzoyl compound. These compounds may have a substituent. Preferred examples of the substituent include an alkyl group, an alkoxy group, an acyl group, an acyloxy group, a cyano group, an alkoxycarbonyl group, a halogen atom, an aryl group, and an aralkyl group.

The addition amount of the compound (B) is preferably 0.0001 mass % or greater, more preferably 0.0005 mass % or greater, and still more preferably 0.001 mass % or greater, with respect to the entire liquid electrolyte. The upper limit thereof is preferably 10 mass % or less, more preferably 1 mass % or less, and particularly preferably 0.1 mass % or less.

The addition amount ratio (AB) of the compound (A) to the compound (B) is preferably 100/1 or less, and more preferably 50/1 or less, in terms of mass ratio. The lower limit thereof with respect to compound (A) is preferably 1/10 or more, more preferably 1/1 or more, and particularly preferably 2/1 or more.

It is noted that in this specification, the representation of the compound (for example, when the name of a chemical is called by putting the term “compound” at the foot of the chemical name) is used in the sense that not only the compound itself, but also its salt, and its ion are incorporated therein. Further, it is used in the sense that the compound includes a derivative thereof which is modified in a predetermined part, for example, by introducing a substituent, in the range of achieving a desired effect.

In this specification, a substituent (a linking group is also the same) that is not specified by substitution or non-substitution means that the substituent may have an optional substituent. This is applied to the compound that is not specified by substitution or non-substitution. Preferable examples of the substituent include the substituent T described below.

Examples of the substituent T include: an alkyl group (preferably an alkyl group having 1 to 20 carbon atoms, e.g. methyl, ethyl, isopropyl, t-butyl, pentyl, heptyl, 1-ethylpentyl, benzyl, 2-ethoxyethyl, or 1-carboxymethyl), an alkenyl group (preferably an alkenyl group having 2 to 20 carbon atoms, e.g. vinyl, allyl, or oleyl), an alkynyl group (preferably an alkynyl group having 2 to 20 carbon atoms, e.g. ethynyl, butadiynyl, or phenylethynyl), a cycloalkyl group (preferably a cycloalkyl group having 3 to 20 carbon atoms, e.g. cyclopropyl, cyclopentyl, cyclohexyl, or 4-methylcyclohexyl), an aryl group (preferably an aryl group having 6 to 26 carbon atoms, e.g. phenyl, 1-naphthyl, 4-methoxyphenyl, 2-chlorophenyl, or 3-methylphenyl), a heterocyclic group (preferably a heterocyclic group having 2 to 20 carbon atoms, more preferably a 5- or 6-membered heterocyclic group having at least one oxygen atom, sulfur atom or nitrogen atom, e.g. 2-pyridyl, 4-pyridyl, 2-imidazolyl, 2-benzimidazolyl, 2-thiazolyl, or 2-oxazolyl), an alkoxy group (preferably an alkoxy group having 1 to 20 carbon atoms, e.g. methoxy, ethoxy, isopropyloxy, or benzyloxy), an aryloxy group (preferably an aryloxy group having 6 to 26 carbon atoms, e.g. phenoxy, 1-naphthyloxy, 3-methylphenoxy, or 4-methoxyphenoxy), an alkoxycarbonyl group (preferably an alkoxycarbonyl group having 2 to 20 carbon atoms, e.g. ethoxycarbonyl, or 2-ethylhexyloxycarbonyl), an amino group (preferably an amino group, an alkylamino group and an arylamino group each having 0 to 20 carbon atoms, e g amino, N,N-dimethylamino, N,N-diethylamino, N-ethylamino, or anilino), a sulfamoyl group (preferably a sulfamoyl group having 0 to 20 carbon atoms, e.g. N,N-dimethylsulfamoyl, or N-phenylsulfamoyl), an acyl group (preferably an acyl group having 1 to 20 carbon atoms, e.g. acetyl, propionyl, butyryl, or benzoyl), an acyloxy group (preferably an acyloxy group having 1 to 20 carbon atoms, e.g. acetyloxy, or benzoyloxy), a carbamoyl group (preferably a carbamoyl group having 1 to 20 carbon atoms, e.g. N,N-dimethylcarbamoyl, or N-phenylcarbamoyl), an acylamino group (preferably an acylamino group having 1 to 20 carbon atoms, e.g. acetylamino, or benzoylamino), a sulfonamide group (preferably a sulfonamide group having 0 to 20 carbon atoms, e.g. methane sulfonamide, benzene sulfonamide, N-methyl methane sulfonamide, or N-ethyl benzene sulfonamide), an alkylthio group (preferably an alkylthio group having 1 to 20 carbon atoms, e.g. methylthio, ethylthio, isopropylthio, or benzylthio), an arylthio group (preferably an arylthio group having 6 to 26 carbon atoms, e.g. phenylthio, 1-naphthylthio, 3-methylphenylthio, or 4-methoxyphenylthio), an alkyl- or aryl-sulfonyl group (preferably an alkyl- or aryl-sulfonyl group having 1 to 20 carbon atoms, e.g. methylsulfonyl, ethylsulfonyl, or benzene sulfonyl), a hydroxy group, a cyano group, and a halogen atom (e.g. a fluorine atom, a chlorine atom, a bromine atom, or an iodine atom). Among these, an alkyl group, an alkenyl group, an aryl group, a heterocyclic group, an alkoxy group, an aryloxy group, an alkoxycarbonyl group, an amino group, an acylamino group, a hydroxy group, and a halogen atom are more preferable; and an alkyl group, an alkenyl group, a heterocyclic group, an alkoxy group, an alkoxycarbonyl group, an amino group, an acylamino group, and a hydroxy group are particularly preferable.

Moreover, each group exemplified as the substituent T may be further substituted with the above-described substituent T.

When a compound, a substituent, a linking group or the like contains an alkyl group, an alkylene group, an alkenyl group, an alkenylene group or the like, each of these groups may be a cyclic group or a chain group, may be linear or branched, and may be substituted or unsubstituted as described above. Furthermore, when the compound, the substituent, the linking group or the like contains an aryl group, a heterocyclic group or the like, each of them may be monocyclic or fused-cyclic, and may be substituted or unsubstituted as described above.

### (Organic Solvent)

Examples the organic solvent that can be used in the present invention include cyclic carbonates, such as ethylene carbonate, propylene carbonate, and butylene carbonate; linear carbonates, such as dimethyl carbonate, diethyl carbonate, ethyl methyl carbonate, and methyl propyl carbonate; cyclic esters, such as γ-butyrolactone, and γ-valerolactone; linear esters, such as 1,2-dimethoxyethane, and diethylene glycol dimethyl ether; cyclic ethers, such as tetrahydrofuran, 2-methyltetrahydrofuran, tetrahydropyran, 1,3-dioxolane, 4-methyl-1,3-dioxolane, 1,3-dioxane, and 1,4-dioxane; linear esters, such as methyl acetate, ethyl acetate, methyl propionate, ethyl propionate, methyl butyrate, methyl isobutyrate, methyl trimethylacetate, and ethyl trimethylacetate; nitrile compounds, such as acetonitrile, glutaronitrile, adiponitrile, methoxyacetonitrile, and 3-methoxypropionitrile; N,N-dimethylformamide, N-methylpyrrolidinone, N-methyl oxazolidinone, N,N′-dimethylimidazolidinone, nitromethane, nitroethane, sulfolane, trimethyl phosphate, dimethyl sulfoxide, and dimethyl sulfoxide phosphate. These may be used singly or in combination of two or more. Of these, at least one selected from the group consisting of cyclic carbonates (preferably ethylene carbonate, and propylene carbonate), linear carbonates (preferably dimethyl carbonate, diethyl carbonate, and ethyl methyl carbonate), and cyclic esters (preferably γ-butyrolactone) is preferred; and a solvent containing a cyclic carbonate and a linear carbonate, and a solvent containing a cyclic carbonate and a cyclic ester are more preferred. In particular, a combination of a high-viscosity (high-dielectric constant) solvent (for example, having a relative permittivity c of 30 or more), such as ethylene carbonate or propylene carbonate, with a low-viscosity solvent (for example, having a viscosity of up to 1 m·Pas), such as dimethyl carbonate, ethyl methyl carbonate, diethyl carbonate or γ-butyrolactone, is more preferred, because the dissociation ability and the ionic mobility of the electrolytic salt are improved.

However, the organic solvent (non-aqueous solvent) to be used in the present invention is not limited by the foregoing exemplified ones.

### (Electrolyte)

An electrolyte that can be used in the liquid electrolyte of the present invention includes a metal ion or a salt thereof, and a metal ion belonging to Group I or Group II of the Periodic Table or a salt thereof are preferable. The electrolyte is suitably selected depending on the purpose of a liquid electrolyte. For example, lithium salts, potassium salts, sodium salts, calcium salts, and magnesium salts can be mentioned. In the case where the liquid electrolyte is used in a secondary battery or the like, from the viewpoint of the output power of the secondary battery, a lithium salt is preferred. In a case of using the liquid electrolyte of the present invention as the electrolyte of a non-aqueous liquid electrolyte for lithium secondary batteries, it is desirable to select a lithium salt as the salt of the metal ion. The lithium salt is preferably a lithium salt that is usually used in the electrolyte of a non-aqueous liquid electrolyte for lithium secondary batteries, and, for example, the salts described below are preferred.

(L-1) Inorganic lithium salt: inorganic fluoride salt, such as LiPF₆, LiBF₄, LiAsF₆, LiSbF₆; perhalogenic acid salts, such as LiClO₄, LiBrO₄, LiIO₄; and inorganic chloride salt, such as LiAlCl₄, and the like.
(L-2) Organic lithium salt containing fluorine: perfluoroalkanesulfonic acid salts, such as LiCF₃SO₃; perfluoroalkanesulfonylimide salts, such as LiN(CF₃SO₂)₂, LiN(CF₃CF₂SO₂)₂, LiN(FSO₂)₂, and LiN(CF₃SO₂)(C₄F₉SO₂); perfluoroalkanesulfonylmethide salts, such as LiC(CF₃SO₂)₃; fluoroalkyl fluorophosphoric acid salts, such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃], and the like.
(L-3) Oxalatoborate salts: lithium bis(oxalate)borate, lithium difluoro(oxalate)borate, and the like.

Among these, LiPF₆, LiBF₄, LiAsF₆, LiSbF₆, LiClO₄, Li(Rf¹SO₃), LiN(Rf¹ SO₂)₂, LiN(FSO₂)₂, and LiN(Rf¹SO₂)(Rf²SO₂)₂, are preferred; and lithium imide salts, such as LiPF₆, LiBF₄, LiN(Rf¹SO₂)₂, LiN(FSO₂)₂, and LiN(Rf¹ SO₂)(Rf²SO₂)₂, are more preferred. Herein, Rf¹ and Rf² each represent a perfluoroalkyl group.

As for the electrolyte that is used in the liquid electrolyte, one kind may be used singly, or any two or more kinds may be used in combination.

The electrolyte is added to the liquid electrolyte in such an amount that the electrolyte is contained at a preferred salt concentration to be mentioned in the method of preparing the liquid electrolyte below. The salt concentration is selected according to the intended purpose of the liquid electrolyte, but the content is usually from 10 mass % to 50 mass %, and more preferably from 15 mass % to 30 mass %, relative to the total mass of the liquid electrolyte. When evaluated as the ionic concentration, the salt concentration need only be calculated in terms of the salt with a favorably applied metal.

### (Other Components)

In the liquid electrolyte of the present invention, various additives can be used in accordance with the purpose, in order to enhance the performance, safety and durability of the battery, to the extent that the effects of the present invention are not impaired. As for such additives, functional additives may be used, such as an overcharge preventing agent, a negative electrode film forming agent, a positive electrode protective agent, and a flame retardant.

Specifically, the additives include: carbonate compounds, such as vinylene carbonate, vinylethylene carbonate, fluoroethylene carbonate, and difluoroethylene carbonate; sulfur-containing compounds, such as ethylene sulfite, propane sulfite, and sulfonic acid esters; aromatic compounds, such as biphenyl, cyclohexyl benzene, and t-amyl benzene; and phosphorus compounds, such as phosphoric acid esters. The content ratio of these other additives in the non-aqueous liquid electrolyte is not particularly limited, but is each preferably 0.01 mass % or more, particularly preferably 0.1 mass % or more, and further preferably 0.2 mass % or more, with respect to the whole organic components of the non-aqueous liquid electrolyte. The upper limit of the content ratio is preferably 5 mass %, particularly preferably 3 mass %, and further preferably 2 mass %. The addition of these compounds allows rupture and ignition of a battery to be restrained in disorder due to overcharge, and allows capacity retention characteristics and cycling characteristics to be improved after preserving at high temperature. The addition of these compounds allows rupture and ignition of a battery to be restrained in disorder due to overcharge, and allows capacity retention characteristics and cycling characteristics to be improved after preserving at high temperature.

### [Method of Preparing Liquid Electrolyte and the Like]

The non-aqueous liquid electrolyte for a secondary battery of the present invention is prepared in a usual manner, in such a manner that the above-mentioned each component is dissolved in the non-aqueous liquid electrolyte solvent, including an example using a lithium salt as a salt of a metal ion.

The term “non-aqueous” as used in the present invention means that water is substantially not contained, and a small amount of water may be contained as long as the effects of the present invention are not impaired. In consideration of obtaining good properties, water is preferably contained in an amount of up to 200 ppm (mass standard), and more preferably up to 100 ppm. Although the lower limit is not particularly limited, it is practical for the water content to be 1 ppm or more, taking into consideration of inevitable incorporation. Although the viscosity of the liquid electrolyte of the present invention is not particularly limited, the viscosity at 25° C. is preferably 10 to 0.1 mPa·s, more preferably 5 to 0.5 mPa·s.

### [Secondary Battery]

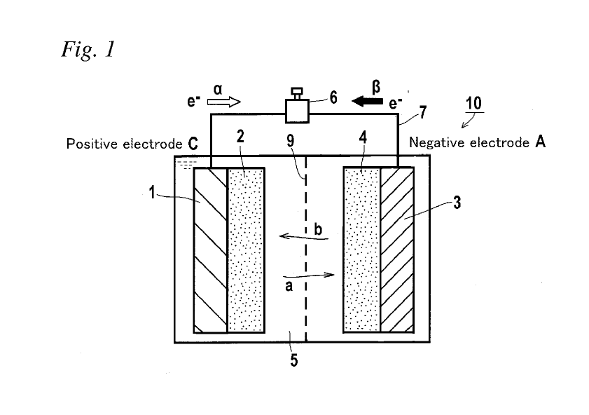

In the present invention, a non-aqueous secondary battery preferably contains the above-mentioned non-aqueous liquid electrolyte. A preferable embodiment is described while referring to FIG. 1 schematically illustrating a mechanism of a lithium ion secondary battery. The lithium ion secondary battery 10 of the present embodiment contains the above-described non-aqueous liquid electrolyte 5 for a secondary battery of the present invention, a positive electrode C (a current collector for positive electrode 1, a positive electrode active material layer 2) capable of insertion and release of lithium ions, and a negative electrode A (a current collector for negative electrode 3, a negative electrode active material layer 4) capable of insertion and discharge, or dissolution and precipitation, of lithium ions. In addition to these essential members, the lithium ion secondary battery may also be constructed to contain a separator 9 that is disposed between the positive electrode and the negative electrode, current collector terminals (not shown), and an external case (not shown), in consideration of the purpose of using the battery, the form of the electric potential, and the like. According to the necessity, a protective element may also be mounted in at least any one side of the interior of the battery and the exterior of the battery. By employing such a structure, transfer of lithium ions a and b occurs in the liquid electrolyte 5, and charging a and discharging β can be carried out. Thus, operation and accumulation can be carried out by means of an operating means 6 through the circuit wiring 7. The configuration of the lithium secondary battery, which is a preferable embodiment of the present invention, will be described in detail below.

### (Battery Shape)

There are no particular limitations on the battery shape that is applied to the lithium secondary battery of this embodiment, and examples of the shape include a bottomed cylindrical shape, a bottomed rectangular shape, a thin flat shape, a sheet shape, and a paper shape. The lithium secondary battery of this embodiment may have any of these shapes. Furthermore, an atypical shape may also be used, such as a horseshoe shape or a comb shape, which is designed in consideration of the form of the system or device into which the lithium secondary battery is incorporated. Among them, from the viewpoint of efficiently releasing the heat inside of the battery to the outside thereof, a rectangular shape is preferred, such as a bottomed rectangular shape or a thin flat shape, which has at least one relatively flat and large-sized surface.

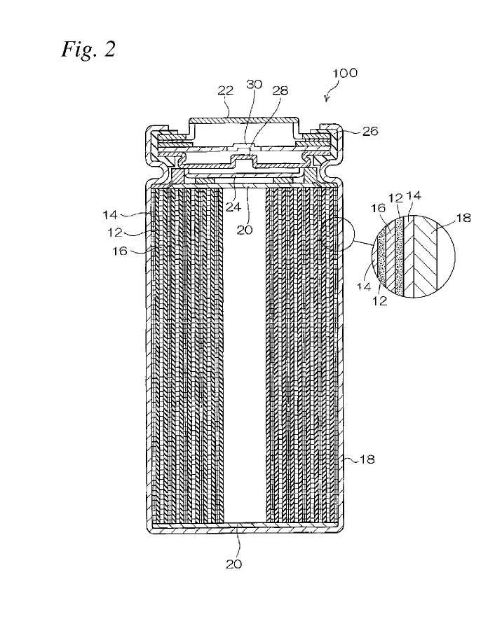

In a battery having a bottomed cylindrical shape, since the external surface area relative to the power generating element to be charged is small, it is preferable to design the battery such that the Joule heating that is generated due to the internal resistance at the time of charging or discharging is efficiently dissipated to the outside. Further, it is preferable to design the lithium secondary battery such that the filling ratio of a substance high in heat conductivity is increased, so as to decrease the temperature distribution inside the battery. FIG. 2 is an example of a bottomed cylindrical lithium secondary battery 100. This battery is a bottomed cylindrical lithium secondary battery 100 in which a positive electrode sheet 14 and a negative electrode sheet 16 that are superimposed with a separator 12 interposed therebetween, are wound and stored in a packaging can 18.

With regard to the bottomed rectangular shape, it is preferable that the value of the ratio of twice the area of the largest surface, S (the product of the width and the height of the external dimension excluding terminal areas, unit cm²) and the external thickness of the battery, T (unit cm), 2S/T, be 100 or greater, and more favorably 200 or greater. By having the largest surface made large, even in the case of batteries of high output power and large capacity, characteristics, such as cycle characteristics and high-temperature storage, can be enhanced, and also, the heat dissipation efficiency at the time of abnormal heat generation can be increased. Thus, it is advantageous from the viewpoint that “valve action” or “bursting”, which will be described below, can be prevented.

### (Battery-Constituting Members)

The lithium secondary battery of this embodiment is constituted to contain the liquid electrolyte 5, an electrode mixture of the positive electrode C and the negative electrode A, and a basic member of the separator 9, based on FIG. 1. These members will be described below.

### (Electrode Mixtures)

An electrode mixture is a composite obtained by applying an active substance, and a dispersion of an electroconductive agent, a binder, a filler and the like, on a current collector (an electrode substrate). For a lithium battery, a positive electrode mixture in which the active substance is a positive electrode active substance, and a negative electrode mixture in which the active substance is a negative electrode active substance are preferably used. Next, each component in dispersions composing the electrode mixture (a composition for electrode) is described.

Positive Electrode Active Substance

As a positive electrode active substance, a particulate positive electrode active substance may be used. Specifically, although as the positive electrode active substance, a transition metal oxide which is capable of reversible insertion and release of lithium ions can be used, it is preferable to use a lithium-containing transition metal oxide. Suitable examples of a lithium-containing transition metal oxide that is preferably used as a positive electrode active substance, include oxides containing one or more of lithium-containing Ti, lithium-containing V, lithium-containing Cr, lithium-containing Mn, lithium-containing Fe, lithium-containing Co, lithium-containing Ni, lithium-containing Cu, lithium-containing Mo, and lithium-containing W.

Furthermore, alkali metals other than lithium (elements of Group 1 (Ia) and Group 2 (IIa) of the Periodic Table of Elements), and/or Al, Ga, In, Ge, Sn, Pb, Sb, Bi, Si, P, B and the like may also be incorporated. The amount of incorporation is preferably from 0 mol % to 30 mol % relative to the amount of the transition metal.

Among the lithium-containing transition metal oxides that are preferably used as the positive electrode active substance, a substance synthesized by mixing a lithium compound and a transition metal compound (herein, the transition metal refers to at least one selected from Ti, V, Cr, Mn, Fe, Co, Ni, Mo, and W) is more preferred, such that the total molar ratio of the lithium compound/transition metal compound is 0.3 to 2.2.

Furthermore, among the lithium compound/transition metal compound, particularly preferred are materials containing Li_{g}M3O₂ (wherein M3 represents one or more elements selected from Co, Ni, Fe, and Mn; and g represents 0 to 1.2), or materials having a spinel structure represented by LiₕM4₂O (wherein M4 represents Mn; and h represents 0 to 2). As M3 and M4 described above, Al, Ga, In, Ge, Sn, Pb, Sb, Bi, Si, P, B, or the like may also be incorporated, in addition to the transition metal. The amount of incorporation is preferably from 0 mol % to 30 mol %, relative to the amount of the transition metal.

Among the materials containing Li_{g}M3O₂ and the materials having a spinel structure represented by LiₕM4₂O₄, particularly preferred are Li_{g}CoO₂, Li_{g}NiO₂, Li_{g}MnO₂, Li_{g}CoⱼNi₁₋ⱼO₂, LiₕMn₂O₄, LiNiⱼMn₁₋ⱼO₂, LiCoⱼNiₕMn₁₋ⱼ₋ₕO₂, LiMnₕAl₂₋ₕO₄, and LiMnₕNi₂₋ₕO₄ (wherein in the respective formulas, g represents 0.02 to 1.2; j represents 0.1 to 0.9; and h represents 0 to 2); and most preferred are Li_{g}CoO₂, LiMn₂O₄, LiNi_{0.85}Co_{0.01}Al_{0.05}O₂, and LiNi_{0.33}Co_{0.33}Mn_{0.33}O₂. From the viewpoints of high capacity and high power output, among those described above, an electrode containing Ni is more preferred. Herein, the g value and the h value are values prior to the initiation of charging and discharging, and are values that increase or decrease as charging or discharging occurs. Specific examples thereof include LiCoO₂, LiNi_{0.5}Mn_{0.5}O₂, LiNi_{0.85}Co_{0.01}Al_{0.05}O₂, LiNi_{0.33}Co_{0.33}Mn_{0.33}O₂, LiMn_{1.8}Al_{0.2}O₄, and LiMn_{1.5}Ni_{0.5}O₄.

Preferred examples of the transition metal of the lithium-containing transition metal phosphate compound include V, Ti, Cr, Mn, Fe, Co, Ni, and Cu, and specific examples of the compound include iron phosphates, such as LiFePO₄, Li₃Fe₂(PO₄)₃, and LiFeP₂O₇; cobalt phosphates, such as LiCoPO₄; and compounds in which a portion of the transition metal atoms that constitute the main component of these lithium-transition metal phosphate compounds has been substituted by another metal, such as Al, Ti, V, Cr, Mn, Fe, Co, Li, Ni, Cu, Zn, Mg, Ga, Zr, Nb, or Si.

The average particle size of the positive electrode active substance, which cam be used in the non-aqueous electrolyte secondary battery of the present invention, is not particularly limited, but the average particle size is preferably from 0.1 μm to 50 μm. The specific surface area is not particularly limited, but specific surface area as measured by the BET method is preferably from 0.01 m²/g to 50 m²/g. Furthermore, the pH of the supernatant obtainable when 5 g of the positive electrode active substance is dissolved in 100 mL of distilled water, is preferably from 7 to 12.

In order to adjust the positive electrode active substance to a predetermined particle size, a well-known pulverizer or classifier may be used. For example, a mortar, a ball mill, a vibrating ball mill, a vibrating mill, a satellite ball mill, a planetary ball mill, a swirling air flow jet mill, or a sieve is used. The positive electrode active substance obtained according to the calcination method may be used after washing the substance with water, an acidic aqueous solution, an alkaline aqueous solution, or an organic solvent.

In the present invention, a material having a charge range of 4.25V or more is preferably used, as a positive electrode active material. Examples of the positive electrode active material which has the above-described particular charge range include the following materials.

(i) LiNiₓMn_{y}Co_{z}O₂ (x>0.2, y>0.2, z≧0, x+y+z=1),

### Representative Examples

LiNi_{1/3}Mn_{1/3}CO_{1/3}O₂ (also described as LiNi_{0.33}Mn_{0.33}Co_{0.33}O₂)

LiNi_{1/2}Mn_{1/2}O₂ (also described as LiNi_{0.5}Mn_{0.5}O₂)

(ii) LiNiₓCo_{y}Al_{z}O₂ (x>0.7, y>0.1, 0.1>z>0.05, x+y+z=1)

### Representative Examples

LiNi_{0.8}Co_{0.15}Al_{0.05}O₂

As for the positive electrode active material which has the above-described particular charge range, the following materials also can be used.

(a) LiCoMnO₄

(b) Li₂FeMn₃O₈

(c) Li₂CuMn₃O₈

(d) Li₂CrMn₃O₈

(e) Li₂NiMn₃O₈

Further, a solid solution-based positive electrode material (for example, Li₂MnO₃—LiMO₂ (M: a metal, such as Ni, Co, Mn or the like) that exhibits a high potential of about 5 V and very high-specific capacitance exceeding 250 mAh/g has been drawing remarkable attention as a positive electrode material for a next generation of lithium-ion battery. It is also preferable that the liquid electrolyte of the present invention is combined with such solid solution-based positive electrode materials.

Negative Electrode Active Substance

The negative electrode active substance is preferably a negative electrode active substance that is capable of reversible insertion and release of lithium ions, and there is no particular limitation thereon. Examples thereof include carbonaceous materials; metal oxides, such as tin oxide and silicon oxide; metal composite oxides; simple lithium substance or lithium alloys, such as a lithium-aluminum alloy; and metals capable of forming an alloy with lithium, such as Sn and Si.

For these materials, one kind may be used singly, or two or more kinds may be used in any combination at any proportions. Among them, carbonaceous materials or lithium composite oxides are preferably used, from the viewpoint of safety.

Furthermore, the metal composite oxides are not particularly limited and are preferably materials that are capable of adsorption and release of lithium, but it is preferable for the composite oxides to contain titanium and/or lithium as constituent components, from the viewpoint of high current density charging-discharging characteristics.

The carbonaceous material that is used as the negative electrode active substance is a material which is substantially composed of carbon. Examples thereof include petroleum pitch, natural graphite; artificial graphite, such as vapor-grown graphite; and carbonaceous materials obtained by firing various synthetic resins, such as PAN-based resins and furfuryl alcohol resins. Further, the examples include various carbon fibers, such as PAN-based carbon fibers, cellulose-based carbon fibers, pitch-based carbon fibers, vapor-grown carbon fibers, dehydrated PVA-based carbon fibers, lignin carbon fibers, vitreous carbon fibers, and activated carbon fibers; mesophase microspheres, graphite whiskers, and tabular graphite.

These carbonaceous materials may be classified into hardly graphitized carbon materials and graphite-based carbon materials, according to the degree of graphitization. Also, it is preferable that the carbonaceous materials have the plane spacing, density, and size of crystallites, as described in JP-A-62-22066, JP-A-2-6856, and JP-A-3-45473. The carbonaceous materials are not necessarily single materials, and use can also be made of a mixture of natural graphite and an artificial graphite as described in JP-A-5-90844, a graphite having a coating layer as described in JP-A-6-4516, and the like.

In regard to the metal oxides and metal composite oxides, each of which are negative electrode active substances, at least one of these is preferably contained in the battery. The metal oxides and metal composite oxides are particularly preferably amorphous oxides, and furthermore, chalcogenides which are reaction products of metal elements and the elements of Group 16 of the Periodic Table of Elements are also preferably used. The term amorphous as used herein means that the substance has a broad scattering band having an apex at a 2θ value in the range of 20° to 40°, as measured by an X-ray diffraction method using CuKα radiation, and the substance may also have crystalline diffraction lines. The highest intensity obtainable among the crystalline diffraction lines exhibited at a 2θ value in the range of from 40° to 70° is preferably 100 times or less, and more preferably 5 times or less, than the diffraction line intensity of the apex of the broad scattering band exhibited at a 20 value in the range of from 20° to 40°, and it is particularly preferable that the substance does not have any crystalline diffraction line.

Among the group of compounds composed of the amorphous oxides and chalcogenides, amorphous oxides and chalcogenides of semi-metallic elements are more preferred, and oxides and chalcogenides formed from one kind singly or combinations of two or more kinds of the elements of Group 13 (IIIB) to Group 15 (VB) of the Periodic Table of Elements, Al, Ga, Si, Sn, Ge, Pb, Sb and Bi are particularly preferred. Specific preferred examples of the amorphous oxides and chalcogenides include, for example, Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. Furthermore, these may also be composite oxides with lithium oxide, for example, Li₂SnO₂.

The average particle size of the negative electrode active substance that can be used in the non-aqueous secondary battery of the present invention is preferably from 0.1 μm to 60 μm. In order to adjust the negative electrode active substance to a predetermined particle size, a well-known pulverizer or classifier may be used. For example, a mortar, a ball mill, a sand mill, a vibrating ball mill, a satellite ball mill, a planetary ball mill, a swirling air flow jet mill, and a sieve are favorably used. At the time of pulverization, wet pulverization of using water or an organic solvent, such as methanol, to co-exist with the negative electrode active substance can also be carried out as necessary. In order to obtain a desired particle size, it is preferable to perform classification. There are no particular limitations on the classification method, and a sieve, an air classifier or the like can be used as necessary. Classification may be carried out by using a dry method, as well as a wet method.

The chemical formula of the compound obtained by the calcination method can be obtained by using an inductively coupled plasma (ICP) emission spectroscopic method as a measurement method, and computed from the mass difference of the powder measured before and after calcination, as a convenient method.

Suitable examples of the negative electrode active substance that can be used together with the amorphous oxide negative electrode active substances typically containing any of Sn, Si and Ge, include carbon materials that are capable of adsorption and release of lithium ions or lithium metal, as well as lithium, lithium alloys, and metals capable of alloying with lithium.

The liquid electrolyte of the present invention can exert excellent characteristics in any of the combination with a high-potential negative electrode (preferably lithium titanium oxide, potential 1.55 V versus Li metal) and the combination with a low-potential negative electrode (preferably carbon material, potential about 0.1V versus Li metal), each of which is a preferable embodiment of the present invention. Further, the liquid electrolyte of the present invention can be preferably used in a battery having: a negative electrode of a metal or metal oxide which is capable of forming an alloy with lithium and is under development toward enhancement of high-capacity (preferably Si, Si oxide, Si/Si oxide, Sn, Sn oxide, SnBₓP_{y}O_{z}, Cu/Sn, and a composite body of two or more kinds of these materials); or a negative electrode which is composed of a composite body of such a metal or metal oxide with a carbon material.

In the present invention, it is preferable to use lithium titanate, more specifically lithium titanium oxide (Li[Li_{1/3}Ti_{5/3}]O₄), as an active material of the negative electrode. By using any of those as a negative electrode active material, the effects due to the compound represented by formula (A) or a combination thereof together with the compound (B) are enhanced further, whereby more excellent battery performances can be exhibited.

Electroconductive Material

The electroconductive material is preferably an electron-conductive material which causes no chemical change, in a constructed secondary battery, and any electroconductive material can be used. Generally, electroconductive materials, such as natural graphite (e.g. scale-like graphite, flaky graphite, earthly graphite), artificial graphite, carbon black, acetylene black, Ketjen black, carbon fibers, metal powders (e.g. copper, nickel, aluminum, and silver (as described in JP-A-63-10148, 554)), metal fibers, and polyphenylene derivatives (as described in JP-A-59-20,971) can be contained singly or as a mixture thereof. Among them, a combination of graphite and acetylene black is particularly preferred. The amount of addition of the electroconductive agent is preferably from 1 mass % to 50 mass %, and more preferably from 2 mass % to 30 mass %. In the case of carbon or graphite, the amount of addition is particularly preferably from 2 mass % to 15 mass %.

Binder

Examples of the binder include polysaccharides, thermoplastic resins, and polymers having rubber elasticity, and among them, preferred examples include emulsions (latexes) or suspensions of starch, carboxymethyl cellulose, cellulose, diacetyl cellulose, methyl cellulose, hydroxyethyl cellulose, hydroxypropyl cellulose, sodium alginate; water-soluble polymers, such as poly(acrylic acid), poly(sodium acrylate), polyvinylphenol, poly(vinyl methyl ether), poly(vinyl alcohol), polyvinylpyrrolidone, polyacrylonitrile, polyacrylamide, poly(hydroxy(meth)acrylate), and a styrene/maleic acid copolymer; poly(vinyl chloride), polytetrafluoroethylene, poly(vinylidene fluoride), a tetrafluoroethylene/hexafluoropropylene copolymer, a vinylidene fluoride/tetrafluoroethylene/hexafluoropropylene copolymer, polyethylene, polypropylene, an ethylene/propylene/diene terpolymer (EPDM), a sulfonated EPDM, a poly(vinyl acetal) resin; (meth)acrylic acid ester copolymers containing (meth)acrylic acid esters, such as methyl methacrylate and 2-ethylhexyl acrylate; a (meth)acrylic acid ester/acrylonitrile copolymer; a poly(vinyl ester) copolymer containing a vinyl ester, such as vinyl acetate; a styrene/butadiene copolymer, an acrylonitrile/butadiene copolymer, polybutadiene, a neoprene rubber, a fluorine rubber, poly(ethylene oxide), a polyester polyurethane resin, a polyether polyurethane resin, a polycarbonate polyurethane resin, a polyester resin, a phenolic resin, and an epoxy resin. More preferred examples include a poly(acrylic acid ester)-based latex, carboxymethyl cellulose, polytetrafluoroethylene, and poly(vinylidene fluoride).

As for the binder, one kind may be used singly, or two or more kinds may be used as a mixture thereof. If the amount of addition of the binder is too small, the retention power and the aggregating power of the electrode mixture are weakened. If the amount of addition is too large, the electrode volume increases, and the capacity per unit volume or unit mass of the electrode is decreased. For such reasons, the amount of addition of the binder is preferably from 1 mass % to 30 mass %, and more preferably from 2 mass % to 10 mass %.

Filler

The electrode mixture may contain a filler. Regarding the material that forms the filler, any fibrous material that causes no chemical change in the secondary battery of the present invention is preferable. Generally, use may be made of fibrous fillers formed from olefinic polymers, such as polypropylene and polyethylene, and materials, such as glass and carbon. The amount of addition of the filler is not particularly limited, but the amount of addition is preferably from 0 mass % to 30 mass %, in the dispersion.

Current Collector

As the current collector for the positive and negative electrodes, an electron conductor that causes no chemical change in the non-aqueous electrolyte secondary battery is preferable. Preferred examples of the current collector for the positive electrode include aluminum, stainless steel, nickel, and titanium, as well as aluminum or stainless steel treated with carbon, nickel, titanium, or silver on the surface. Among them, aluminum and aluminum alloys are more preferred.

Preferred examples of the current collector for the negative electrode include aluminum, copper, stainless steel, nickel, and titanium, and more preferred examples include aluminum, copper and copper alloys.

Regarding the shape of the current collector, a film sheet-shaped current collector is usually used, but a net-shaped material, a film sheet formed by punching, a lath material, a porous material, a foam, a material obtained by molding a group of fibers, and the like can also be used. The thickness of the current collector is not particularly limited, but the thickness is preferably from 1 μm to 500 μm. Furthermore, it is also preferable to provide surface unevenness on the surface of the current collector through a surface treatment.

Electrode mixtures for lithium secondary batteries are formed by members appropriately selected from these materials.

### (Separator)

An ordinarily used separator in the art can be used in the present invention. The separator is preferably formed of a material which electronically insulates the positive electrode and the negative electrode, and has mechanical strength, ion permeability, and oxidation-reduction resistance at the surfaces in contact with the positive electrode and the negative electrode. Examples of such a material that may be used include porous polymer materials or inorganic materials, organic-inorganic hybrid materials, and glass fibers. These separators preferably have a shutdown function for securing safety, that is, a function of increasing resistance by blocking the spaces at 80° C. or more, and thereby cutting off the electric current, and the blocking temperature is preferably from 90° C. to 180° C.

The shape of the pores of the separator is usually circular or elliptical, and the size is from 0.05 μm to 30 μm, and preferably from 0.1 μm to 20 μm. Furthermore, as in the case of producing the material by a stretching method or a phase separation method, a material having rod-shaped or irregularly shaped pores may also be used. The proportion occupied by these pores, that is, the pore ratio, is generally 20% to 90%, and preferably 35% to 80%.

Regarding the polymer materials described above, a single material, such as cellulose nonwoven fabric, polyethylene, or polypropylene, may be used, or a composite material of two or more kinds may also be used. A laminate of two or more kinds of finely-porous films that are different in the pore size, pore ratio, pore blocking temperature and the like, is preferred.

As the inorganic material, oxides, such as alumina and silicon dioxide, nitrides, such as aluminum nitride and silicon nitride, and sulfates, such as barium sulfate and calcium sulfate, are used, and a particle-shaped or fiber-shaped material is used. Regarding the form, a thin film-shaped material, such as a nonwoven fabric, a woven fabric, or a finely-porous film is used. In the case of a thin film-shaped material, a material having a pore size of from 0.01 μm to 1 μm and a thickness of from 5 μm to 50 μm is favorably used. In addition to the independent thin film-shaped materials described above, a separator obtained by forming a composite porous layer containing particles of the inorganic substance described above, as a surface layer of the positive electrode and/or the negative electrode by using a binder made of a resin, can be employed. For example, a separator in which alumina particles having a 90% particle size of less than 1 μm are formed on both surfaces of the positive electrode as porous layers by using a binder of a fluororesin, may be used.

### (Preparation of Non-Aqueous Secondary Battery)

As the shape of the non-aqueous secondary battery, any form, such as a sheet form, a rectangular form, or a cylindrical form, can be applied as described above. The mixture of the positive electrode active substance or the negative electrode active substance is mainly used after being applied (coated) on a current collector, dried, and compressed.

Hereinafter, a bottomed cylindrical lithium secondary battery 100 will be taken as an example, and its configuration and a production method thereof will be described, with reference to FIG. 2. In a battery having a bottomed cylindrical shape, since the external surface area relative to the power generating element to be charged is small, it is preferable to design the battery such that the Joule heating that is generated due to the internal resistance at the time of charging or discharging is efficiently dissipated to the outside. Furthermore, it is preferable to design the lithium secondary battery such that the filling ratio of a substance high in high heat conductivity is increased, so as to decrease the temperature distribution inside the battery. FIG. 2 is an example of a bottomed cylindrical lithium secondary battery 100. This battery is a bottomed cylindrical lithium secondary battery 100 in which a positive electrode sheet 14 and a negative electrode sheet 16 that are superimposed with a separator 12 interposed therebetween, are wound and stored in a packaging can 18. In addition, reference numeral 20 in the diagram represents an insulating plate, 22 represents an opening sealing plate, 24 represents a positive electrode current collector, 26 represents a gasket, 28 represents a pressure-sensitive valve body, and 30 represents a current blocking element. The diagram inside the magnified circle is indicated with varying hatchings in consideration of visibility, but the various members are equivalent to the overall diagram by the reference numerals.

First, a negative electrode active substance is mixed with a solution prepared by dissolving a binder, a filler and the like that are used as desired, in an organic solvent, and thus a negative electrode mixture is prepared in a slurry form or in a paste form. The negative electrode mixture thus obtained is uniformly applied over the entire surface of both sides of a metal core as a current collector, and then the organic solvent is removed to form a negative electrode mixture layer. Furthermore, the laminate of the current collector and the negative electrode mixture layer is rolled by using a roll pressing machine or the like, to produce a laminate having a predetermined thickness, thereby for obtaining a negative electrode sheet (electrode sheet). At this time, the application method for each agent, the drying of the thus-applied matter, and the formation method for positive and negative electrodes may be made in a usual manner.

In this embodiment, a cylindrical battery has been explained as an example, but the present invention is not limited to this. For example, positive and negative electrode sheets produced by the methods described above are superimposed with a separator interposed therebetween, and then the assembly may be processed directly into a sheet-like battery. Alternatively, a rectangular-shaped battery may be formed by folding the assembly, inserting the assembly into a rectangular can, electrically connecting the can with the sheets, injecting an electrolyte thereinto, and then sealing the opening by using an opening sealing plate.

In all of the embodiments, a safety valve can be used as an opening sealing plate for sealing the opening. Furthermore, an opening sealing member may be equipped with various safety elements that are conventionally utilized, in addition to the safety valve. For example, as overcurrent preventing elements, any of a fuse, a bimetal, a PTC element and the like is favorably used.

Furthermore, as a countermeasure for an increase in the internal pressure of the battery can, a method of inserting a slit in the battery can, a gasket cracking method, an opening sealing plate cracking method, or a method of disconnecting from a lead plate can be used, in addition to the method of providing a safety valve. Furthermore, a protective circuit incorporated with an overcharge-coping member or an overdischarge-coping member may be provided to a charging machine, or the aforementioned protective circuit may be provided independently.

For the can or the lead plate, a metal or an alloy having electrical conductivity can be used. For example, any of metals, such as iron, nickel, titanium, chromium, molybdenum, copper, and aluminum, or any of alloys thereof is favorably used.

For the welding method that may be used when a cap, a can, a sheet, and a lead plate are welded, any methods (for example, an electric welding method using a direct current or an alternating current, a laser welding method, an ultrasonic welding method) can be used. As the sealing agent for sealing an opening, any of compounds, such as asphalt, and a mixture thereof can be used.

### [Use of Non-Aqueous Secondary Battery]

Non-aqueous secondary batteries of the present invention are applied to various applications, since the secondary batteries having satisfactory cycle characteristics can be produced.

There are no particular limitations on the application embodiment for the non-aqueous secondary battery, but in the case of mounting the non-aqueous secondary battery in electronic equipment, examples of the equipment include notebook computers, pen-input personal computers, mobile personal computers, electronic book players, mobile telephones, cordless phone handsets, pagers, handy terminals, portable facsimiles, portable copying machines, portable printers, headphone stereo sets, video movie cameras, liquid crystal television sets, handy cleaners, portable CD players, mini disc players, electric shavers, transceivers, electronic organizers, calculators, memory cards, portable tape recorders, radios, backup power supplies, and memory cards. Other additional applications for consumer use include automobiles, electromotive vehicles, motors, lighting devices, toys, game players, load conditioners, timepieces, strobes, cameras, and medical devices (pacemakers, hearing aids, shoulder massaging machines, and the like). Furthermore, the non-aqueous secondary battery can be used as various batteries for munition and space batteries. Also, the non-aqueous secondary battery can be combined with a solar cell.

There are no particular limitations on the application embodiment of the non-aqueous liquid electrolyte for a secondary battery of the present invention, but the non-aqueous liquid electrolyte is preferably used for applications in which a high-temperature use is supposed, from the viewpoint that it provides advantages to high-temperature preservation property and high-rate discharge characteristics. For example, electric vehicles and the like are supposed to be exposed under a high temperature outdoors in a charged state. Further, in the electric vehicles, the high-rate discharge is required at the time of starting or acceleration, and thus resistance to deterioration of high-rate discharge capacity even under high-temperature preservation becomes important. The present invention is favorably able to correspond to such types of usage, thereby exerting its excellent effects.

### EXAMPLES

Hereinafter, the present invention will be described in more detail with reference to examples, but the present invention is not limited to these examples. The definition for quantity in the following Examples is mass standard, unless otherwise specified.

### Example 1

### Comparative Example 1

### Preparation of Liquid Electrolyte

The components shown in Table 1 were added to a liquid electrolyte of 1M LiBF₄ ethylene carbonate/γ-butyrolactone at a volume ratio of 3:7, by the amount described in Table 1, to prepare test liquid electrolytes of Examples according to this invention and test liquid electrolytes for comparison. All viscosities at 25° C. of the thus-prepared test liquid electrolytes were 5 mPa·s or less.

The compounds for use, as described in the tables, are shown below.

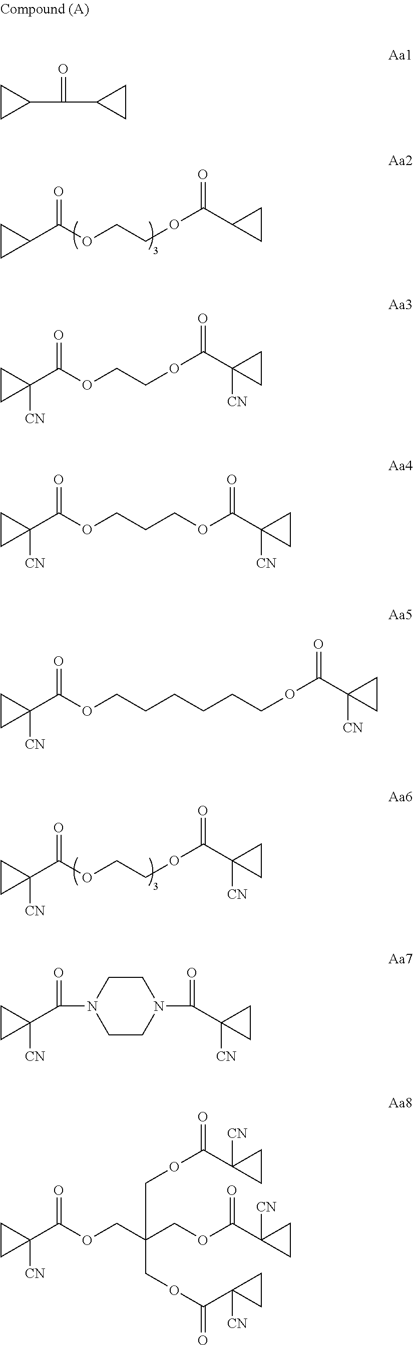

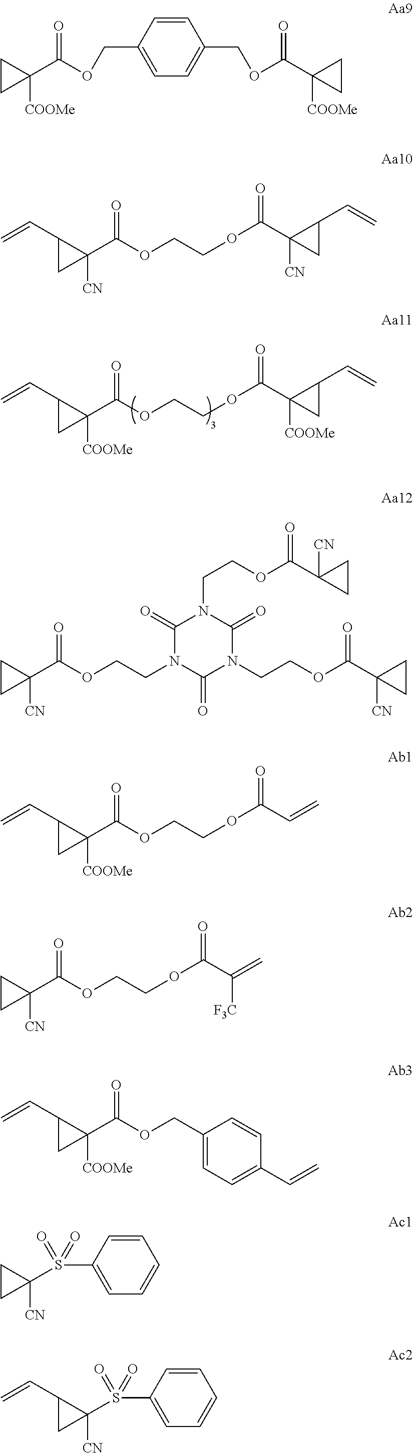

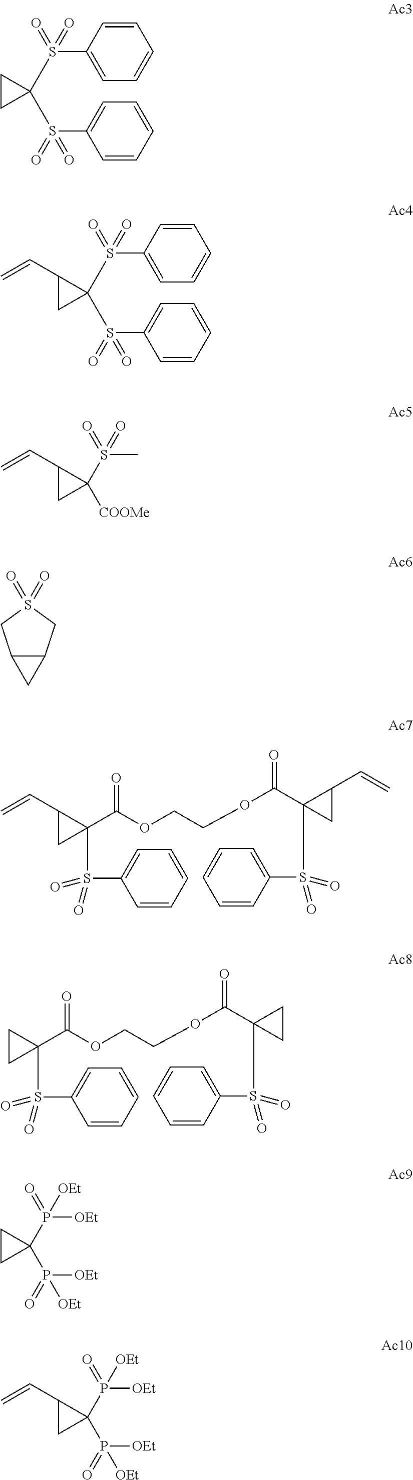

(Ac7 and Ac8 are compounds each of which satisfies the requirements of (Aa) and the requirements of (Ac) at the same time.)

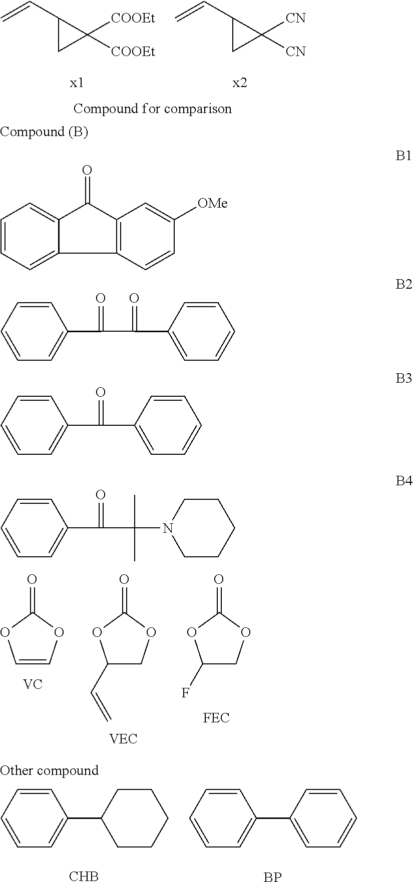

### <Preparation of Battery (1)>

A positive electrode was produced by using an active material: lithium nickel manganese cobalt oxide (LiNi_{1/3}Mn_{1/3}CO_{1/3}O₂) 85% by mass, a conductive aid: carbon black 7% by mass, and a binder: PVDF 8% by mass; and a negative electrode was produced by using an active material: lithium titanium oxide (Li₄Ti₅O₁₂) 94% by mass, a conductive aid: carbon black 3% by mass, and a binder: PVDF 3% by mass. A separator was 50 μm thick made of cellulose. A 2032-type coin battery was produced for each test liquid electrolyte, by using the above-mentioned positive and negative electrodes and separator, to evaluate the following items. The results are shown in Table 1.

The discharge capacities under the following various conditions were calculated. The lithium ion migration becomes slow at a low temperature, and thus more severe conditions are required at the time of a large-current discharge.

### <30° C./1 C Discharge Capacity> (A)

The battery produced by the method described above was used, and in a thermostat chamber at 30° C., the battery was subjected to constant current charging at 0.2 C until the battery voltage reached 2.75 V, then to charging at a constant voltage of 2.75 V until the current value reached 0.12 mA or for 2 hours. Then, the battery was subjected to 0.2 C constant current discharging in a thermostat chamber at 30° C., until the battery voltage reached 1.2 V. Those procedures were repeated twice. Then, the battery was subjected to 0.2 C constant current charging until the battery voltage reached 2.75 V, then to charging at a constant voltage of 2.75 V until the current value reached 0.12 mA or for 2 hours. Then, the battery was subjected to 1 C constant current discharging in a thermostat chamber at 30° C., until the battery voltage reached 1.2 V. For those procedures, the initial 1 C discharge capacity (A) at 30° C. was measured.

### <30° C./4 C Discharge Capacity> (B)

In a thermostat chamber at 30° C., this battery was subjected to 0.2 C constant current charging until the battery voltage reached 2.75 V, then to charging at a constant voltage of 2.75 V until the current value reached 0.12 mA or for 2 hours. Then, the battery was subjected to 4 C constant current discharging in a thermostat chamber at 30° C., until the battery voltage reached 1.2 V. For those procedures, the initial 30° C./4 C discharge capacity (B) was measured.

### <−10° C./4 C Discharge Capacity> (C)

Measurement of the initial 4 C discharge capacity (C) at −10° C. was carried out in the same manner as in the 30° C./4 C discharge capacity (B), except that the temperature of the thermostat chamber at the time when this battery was subjected to discharging was changed to −10° C.

<Discharge Capacity after Cycle Test> (D) (E)

In a thermostat chamber at 30° C., this battery was subjected to 1 C constant current charging until the battery voltage reached 2.75 V, then to charging at a constant voltage of 2.75 V until the current value reached 0.12 mA or for 2 hours, and then to 1 C constant current discharging until the battery voltage reached 1.2 V. This was defined as one cycle. This procedure was repeated up to 300 cycles. After that, the same measurement as in the 30° C./4 C discharge capacity (B) was carried out, to measure 30° C./4 C discharge capacity (D) after the cycle test.

Measurement of −10° C./4 C discharge capacity using this battery without any change was carried out, to measure −10° C./4 C discharge capacity (E) after the cycle test.

The respective discharge capacity retention ratios shown below were evaluated as follows.

TABLE A

| Discharge capacity | |
|---|---|
| retention ratio | Contents |
| (B)/(A) | Discharge capacity retention ratio of 30° C./4C discharge with respect |
| | to initial 30° C./1 C discharge |
| | The larger the value, the higher the initial large-current discharge |
| | efficiency, which indicates a good property. |
| (D)/(B) | Discharge capacity retention ratio of 30° C./4C discharge before and |
| | after 300 cycle test |
| | As the value becomes larger, the large-current discharge efficiency |
| | becomes higher even if a charge/discharge are repeated, which |
| | indicates a good property. |
| (E)/(C) | Discharge capacity retention ratio of −10° C./4C discharge before and |
| | after 300 cycle test |
| | As the value becomes larger, the large-current discharge efficiency |
| | becomes higher even if a charge/discharge are repeated and under |
| | more severe low temperature conditions, which indicates a good |
| | property. |

The respective discharge capacity retention ratios were evaluated on 7 criteria of from a to g. a indicates a best result, and g indicates a conspicuous deterioration of the discharge capacity retention ratio, which is not preferable result.

a: 0.95 or more

b: 0.90 or more, and less than 0.95

c: 0.80 or more, and less than 0.90

d: 0.70 or more, and less than 0.80

e: 0.60 or more, and less than 0.70

f: 0.50 or more, and less than 0.60

g: less than 0.50

TABLE 1

| | Compound (A) | | Compound (B) | | Other component | | Discharge capacity | | |
|---|---|---|---|---|---|---|---|---|---|
| Test | | Conc. | | Conc. | | Conc. | retention ratio | | |
| No. | Comp. | (mass %) | Comp. | (mass %) | Comp. | (mass %) | (B)/(A) | (D)/(B) | (E)/(C) |
| 101 | Aa1 | 0.2 | | | | | b | c | d |
| 102 | Aa2 | 0.2 | | | | | b | c | d |
| 103 | Aa3 | 0.005 | | | | | b | c | d |
| 104 | Aa3 | 0.005 | B2 | 0.005 | | | a | b | c |
| 105 | Aa3 | 0.01 | | | | | a | b | c |
| 106 | Aa3 | 0.2 | | | | | a | b | c |
| 107 | Aa3 | 0.5 | | | | | a | b | c |
| 108 | Aa3 | 1 | | | | | b | c | d |
| 109 | Aa3 | 5 | | | BP | 2 | b | c | e |
| 110 | Aa4 | 0.1 | B2 | 0.05 | CHB | 1 | a | b | c |
| 111 | Aa4 | 0.5 | | | | | a | b | c |
| 112 | Aa4 | 0.2 | | | | | a | b | c |
| 113 | Aa5 | 0.05 | B1 | 0.02 | VC | 0.1 | a | b | c |
| 114 | Aa5 | 0.5 | | | | | a | b | c |
| 115 | Aa6 | 0.2 | | | | | a | b | c |
| 116 | Aa7 | 0.2 | | | | | a | b | c |
| 117 | Aa8 | 0.01 | | | | | a | b | c |
| 118 | Aa9 | 0.2 | | | | | a | b | c |
| 119 | Aa10 | 0.2 | | | | | a | b | c |
| 120 | Aa10 | 0.2 | B4 | 0.1 | VEC | 0.1 | a | b | c |
| 121 | Aa10 | 0.01 | B2 | 0.005 | FEC | 0.01 | a | b | c |
| 122 | Aa11 | 0.2 | | | | | a | b | c |
| 123 | Aa12 | 0.05 | | | | | a | b | c |
| 124 | Ab1 | 0.2 | | | | | b | c | d |
| 125 | Ab1 | 0.2 | B4 | 0.1 | | | a | b | c |
| 126 | Ab2 | 0.2 | | | | | b | c | d |
| 127 | Ab2 | 0.2 | B1 | 0.1 | | | a | b | c |
| 128 | Ab3 | 0.2 | | | | | b | c | d |
| 129 | Ac1 | 5 | | | | | b | c | d |
| 130 | Ac2 | 0.5 | | | | | b | c | d |
| 131 | Ac3 | 0.5 | | | | | b | c | d |
| 132 | Ac4 | 0.5 | | | | | b | c | d |
| 133 | Ac5 | 0.5 | | | | | b | c | d |
| 134 | Ac6 | 0.5 | | | | | b | c | d |
| 135 | Ac7 | 0.2 | | | | | a | b | c |
| 136 | Ac8 | 0.2 | | | | | a | b | c |
| 137 | Ac9 | 0.5 | | | | | b | c | d |
| 138 | Ac10 | 0.5 | | | | | b | c | d |
| c11 | None | | | | | | b | e | g |
| c12 | x1 | 0.2 | | | | | b | d | g |
| c13 | x1 | 1 | | | | | b | d | g |
| c14 | x2 | 0.2 | | | | | b | d | g |
| c15 | x2 | 1 | | | | | b | d | g |
| c16 | None | | | | VC | 0.5 | b | e | g |
| c17 | None | | | | VEC | 0.5 | b | e | g |
| c18 | None | | | | FEC | 0.5 | b | d | g |

<Notes in tables>
Test No.: Nos. beginning with ‘c’ are Comparative examples, and Nos. except those are Examples according to this invention
Comp.: The numbers of Exemplary compound (see the above chemical formulas)
Conc.: Concentration to the total amount of the liquid electrolyte

From the results shown above, it is understood that adoption of the compound (A) as a functional additive for the liquid electrolyte allows improvement in large-current discharge efficiency at both ordinary temperature and extremely low temperature, and enhancement of cycling characteristics are provided.

### Example 2

### Comparative Example 2

### Preparation of Liquid Electrolyte

The components shown in Table 2 were added to a liquid electrolyte of 1M LiPF₆ ethylene carbonate/methyl ethyl carbonate at a volume ratio of 1:2 by the amount described in Table 2, to prepare liquid electrolytes corresponding to each test numbers. All viscosities at 25° C. of the thus-prepared liquid electrolytes were 5 mPa·s or less.

Preparation of Battery (2)

The positive electrode active material in the Battery (1) was replaced with lithium cobalt oxide (LiCoO₂). A negative electrode was produced, by using an active material: graphite 86 mass %, a conductive aid: carbon black 6 mass %, and a binder: PVDF 8 mass %. A separator was 25 μm thick made of polypropylene. A 2032-type coin battery was produced for the liquid electrolyte of each test Nos., by using the above-mentioned positive and negative electrodes and separator, to evaluate the following items. The results are shown in Table 2.

### <Discharge Capacity Retention Ratio>

A test was carried out in the same manner as in Example 1 described above, except that the voltage after charging was changed from 2.75V to 4.2V, and that the lower limit voltage at the time of constant current discharge was changed from 1.2V to 2.75V. The calculation formulas of the respective capacity retention ratio (%) are the same as above.

TABLE 2

| | Compound (A) | | Compound (B) | | Other component | | Discharge capacity | | |
|---|---|---|---|---|---|---|---|---|---|
| Test | | Conc. | | Conc. | | Conc. | retention ratio | | |
| No. | Comp. | (mass %) | Comp. | (mass %) | Comp. | (mass %) | (B)/(A) | (D)/(B) | (E)/(C) |
| 201 | Aa1 | 0.2 | | | | | b | d | e |
| 202 | Aa2 | 0.2 | | | | | b | d | e |
| 203 | Aa3 | 0.005 | | | | | b | d | e |
| 204 | Aa3 | 0.01 | | | | | a | c | e |
| 205 | Aa3 | 0.2 | | | VC | 1 | a | c | e |
| 206 | Aa3 | 0.5 | | | | | a | c | e |
| 207 | Aa3 | 0.5 | B3 | 0.1 | | | a | c | d |
| 208 | Aa3 | 1 | | | | | b | d | e |
| 209 | Aa3 | 5 | | | BP | 2 | b | d | f |
| 210 | Aa4 | 0.1 | B2 | 0.05 | CHB | 1 | a | c | d |
| 211 | Aa4 | 0.5 | | | | | a | c | e |
| 212 | Aa4 | 0.2 | | | | | a | c | e |
| 213 | Aa5 | 0.05 | B1 | 0.02 | VC | 0.1 | a | c | d |
| 214 | Aa5 | 0.5 | | | | | a | c | e |
| 215 | Aa6 | 0.2 | | | | | a | c | e |
| 216 | Aa7 | 0.2 | | | | | a | c | e |
| 217 | Aa8 | 0.01 | | | | | a | c | e |
| 218 | Aa9 | 0.2 | | | | | a | c | e |
| 219 | Aa10 | 0.2 | | | | | a | c | e |
| 220 | Aa10 | 0.2 | B4 | 0.1 | VEC | 0.1 | a | c | d |
| 221 | Aa10 | 0.01 | B2 | 0.005 | FEC | 0.01 | a | c | d |
| 222 | Aa11 | 0.2 | | | | | a | c | e |
| 223 | Aa12 | 0.05 | | | | | a | c | e |
| 224 | Ab1 | 0.2 | | | | | a | c | e |
| 225 | Ab1 | 0.2 | B4 | 0.1 | | | a | c | d |
| 226 | Ab2 | 0.2 | | | | | b | d | e |
| 227 | Ab2 | 0.2 | B1 | 0.1 | | | a | c | e |
| 228 | Ab3 | 0.2 | | | | | b | d | e |
| 229 | Ac1 | 5 | | | | | b | d | e |
| 230 | Ac2 | 0.5 | | | | | b | d | e |
| 231 | Ac3 | 0.5 | | | | | b | d | e |
| 232 | Ac4 | 0.5 | | | | | b | d | e |
| 233 | Ac5 | 0.5 | | | | | b | d | e |
| 234 | Ac6 | 0.5 | | | | | b | d | e |
| 235 | Ac7 | 0.2 | | | | | a | c | e |
| 236 | Ac8 | 0.2 | | | | | a | c | e |
| 237 | Ac9 | 0.5 | | | | | b | d | e |
| 238 | Ac10 | 0.5 | | | | | b | d | e |
| c21 | None | | | | | | b | f | g |
| c22 | x1 | 0.2 | | | | | b | c | g |
| c23 | x1 | 1 | | | | | b | e | g |
| c24 | x2 | 0.2 | | | | | b | e | g |
| c25 | x2 | 1 | | | | | b | c | g |
| c26 | None | | | | VC | 0.5 | b | d | g |
| c27 | None | | | | VEC | 0.5 | b | c | g |
| c28 | None | | | | FEC | 0.5 | b | d | g |

### Example 3

### Comparative Example 3

The respective discharge capacity retention ratios were calculated under the same conditions as in Example 2/Comparative Example 2, except that the positive electrode active material was replaced with LiMn₂O₄. As a result, the liquid electrolyte of the present invention exhibited superior large-current discharge characteristics, as compared to the liquid electrolyte of the Comparative Example, and in particular, exhibited a good −10° C./4 C discharge capacity retention ratio (E)/(C) before and after the cycle test.

From the results shown above, it is understood that the non-aqueous liquid electrolyte for a secondary battery of the present invention exhibits superior performance in terms of large-current discharge characteristics, as compared to those using compound (x1, x2) found in known references, despite the use of a carbon-based negative electrode in which tougher conditions are required when the operation potential is lower.

The above-described Examples showed that excellent characteristics were exhibited in the batteries in which the liquid electrolyte of the present invention was used in combination with a lithium titanium oxide negative electrode or a carbon material negative electrode, as a negative electrode, and lithium nickel manganese cobalt oxide, lithium cobaltate, or lithium manganate, as a positive electrode. However, it is presumed that the liquid electrolyte of the present invention exhibits similarly excellent effects in batteries having: a metal or metal oxide negative electrode which is under development toward higher level of capacity, with the metal or metal oxide being capable of forming an alloy with lithium (preferably Si, Si oxide, Si/Si oxide, Sn, Sn oxide, SnBₓP_{y}O_{z}, Cu/Sn, and a composite body of at least two selected from among these materials); and a negative electrode which is composed of a composite body of such a metal or metal oxide with a carbon material, and/or in batteries having a positive electrode on the order of 4.5V to 5V.

Having described our invention as related to the present embodiments, it is our intention that the invention not be limited by any of the details of the description, unless otherwise specified, but rather be construed broadly within its spirit and scope as set out in the accompanying claims.

1. A non-aqueous liquid electrolyte for a secondary battery, containing: a compound (A) having a cyclopropane structure; an electrolyte; and an organic solvent,
wherein the compound (A) satisfies at least one selected from (Aa) to (Ac):
(Aa) a compound having two or more cyclopropane structures in the molecule thereof
(Ab) a compound having a cyclopropane structure and a group selected from an acryloyl group and a vinylphenyl group
(Ac) a compound having a cyclopropane structure and a group selected from among formulas (Ac-a) to (Ac-c) 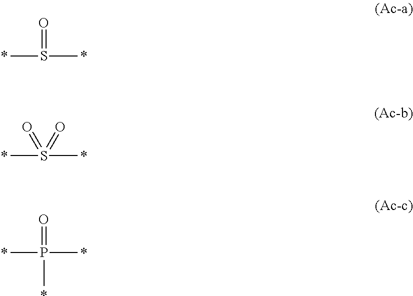
wherein “*” represents a binding site.

2. The non-aqueous liquid electrolyte for a secondary battery according to claim 1, wherein the compound (A) further contains at least one selected from the group consisting of a cyano group and an ester group.

3. The non-aqueous liquid electrolyte for a secondary battery according to claim 1, wherein the cyclopropane structure contained in the compound (A) has a partial structure represented by formula (Aa1): 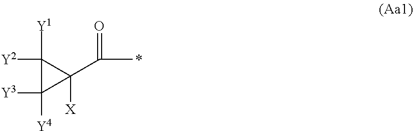
wherein X represents a hydrogen atom or a substituent; and Y¹ to Y⁴ each represent a hydrogen atom or a substituent.

4. The non-aqueous liquid electrolyte for a secondary battery according to claim 1, wherein the compound of (Aa) is a compound represented by formula (Aa3): 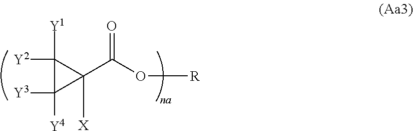
wherein X represents a hydrogen atom or a substituent; Y¹ to Y⁴ each represent a hydrogen atom or a substituent; na represents an integer of from 2 to 6; and R represents a linking group.

5. The non-aqueous liquid electrolyte for a secondary battery according to claim 1, wherein the compound of (Ab) is a compound represented by formula (Ab2): 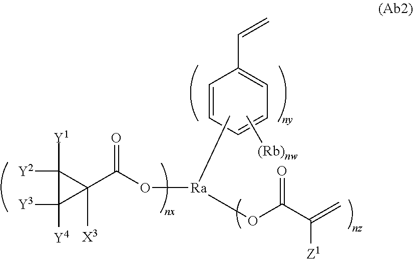
wherein Y¹ to Y⁴ each represent a hydrogen atom or a substituent; Z¹ represents a hydrogen atom, an alkyl group, a fluorine-substituted alkyl group, or a cyano group; X³ represents a hydrogen atom or a substituent; Ra represents a linking group; nx represents an integer of from 1 to 3; ny represents an integer of from 0 to 3; nz represents an integer of from 0 to 3; the sum of ny and nz is an integer of from 1 to 3; Rb represents a substituent; and nw is an integer of from 0 to 4.

6. The non-aqueous liquid electrolyte for a secondary battery according to claim 1, wherein the compound of (Ac) is a compound having a partial structure represented by formula (Ac1): 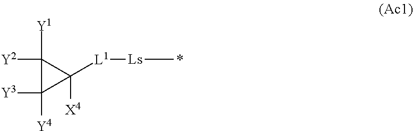
wherein L¹ represents a single bond or a linking group; Ls represents a linking group represented by any one of formulas (Ac-a) to (Ac-c); X represents a hydrogen atom or a substituent; Y¹ to Y⁴ each represent a hydrogen atom or a substituent; “*” represents a binding site; and the “*” site may bind to any one of Y¹ to Y⁴ and X, or may bind to a cyclopropane ring by eliminating any of the Y¹ to Y⁴ and X, to form a ring structure containing Ls.

7. The non-aqueous liquid electrolyte for a secondary battery as according to claim 1, further containing a compound releasing, upon oxidation or reduction, an active species that reacts with the compound (A).

8. A non-aqueous liquid electrolyte secondary battery, containing:
a positive electrode;
a negative electrode; and
the non-aqueous liquid electrolyte according to claim 1.

9. The non-aqueous liquid electrolyte secondary battery according to claim 8, wherein a compound having at least one of nickel, cobalt, or manganese is contained as an active material of the positive electrode.

10. The non-aqueous liquid electrolyte secondary battery according to claim 8, wherein lithium titanium oxide (LTO), a carbon material, or a composite carbon material is contained as an active substance of the negative electrode.

11. An additive for a non-aqueous secondary battery liquid electrolyte, comprising a compound satisfying any one selected from (Aa) to (Ac):
(Aa) a compound having two or more cyclopropane structures in the molecule thereof
(Ab) a compound having a cyclopropane structure and a group selected from an acryloyl group and a vinylphenyl group
(Ac) a compound having a cyclopropane structure and a group selected from among formulas (Ac-a) to (Ac-c) 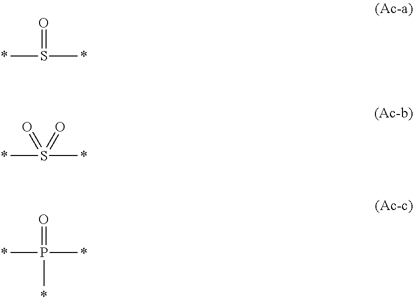
wherein “*” represents a binding site.
